(19) United States
(12) Patent Application Publication
(10) Pub. No.: US 2023/0415123 A1
(43) Pub. Date: Dec. 28, 2023

(54) ARTICLES, SYSTEMS, AND METHODS INCLUDING ARTICLES WITH HALOGEN RESERVOIRS

(71) Applicant: W. L. Gore & Associates, Inc., Newark, DE (US)

(72) Inventors: Franz Shelley, Oxford, PA (US); Steve Hardwick, Newark, DE (US); Lisandra Arroyo Ramirez, Newark, DE (US); Uwe Beuscher, Newark, DE (US); Ryan Kenaley, Hockessin, DE (US)

(21) Appl. No.: 18/036,613

(22) PCT Filed: Nov. 12, 2021
(86) PCT No.: PCT/US2021/059116

§ 371 Date: May 11, 2023

Related U.S. Application Data
(60) Provisional application No. 63/113,047, filed on Nov. 12, 2020.

(51) Int. Cl. B01J 20/28; B01J 20/20; B01J 20/02; B01J 20/26; B01J 20/32; B01D 53/02

(52) U.S. Cl. CPC B01J 20/28026; B01J 20/28023; B01J 20/28028; B01J 20/20; B01J 20/027; B01J 20/261; B01J 20/321; B01J 20/3212; B01J 20/3246; B01J 20/3293; B01D 53/02; B01D 2258/0283; B01D 2257/302; B01D 2257/602; B01D 2253/25; B01D 2253/102; B01D 2253/202

(57) ABSTRACT

A durable pollution control systems, articles, and methods for removing multiple flue gas pollutants. The pollution control system includes an article comprising a sorbent polymer composite (SRC), and a plurality of halogen reservoirs. In some, the halogen reservoirs are embedded within the SRC. In some, each of the halogen reservoirs has 5 wt % to 95 wt % of at least one permeation control material based on an average weight of each halogen reservoir and 5 wt % to 50% of at least one halogen source based on an average weight of each halogen reservoir.

### CROSS-REFERENCE TO RELATED APPLICATIONS

The present application is a national phase application of PCT Application No. PCT/US2021/059116, internationally filed on Nov. 12, 2021, and entitled “ARTICLES, SYSTEMS, AND METHODS INCLUDING ARTICLES WITH HALOGEN RESERVOIRS”, which claims priority to and benefit of U.S. Provisional Patent Application No. 63/113,047, filed Nov. 12, 2020, and entitled “ARTICLES COMPRISING A PLURALITY HALOGEN RESERVOIRS, SYSTEMS AND METHODS INCLUDING THE SAME,” the entireties of which are herein incorporated by reference.

### FIELD

The present disclosure relates to the field of pollution control systems and methods for removing compounds and fine particulate matters from gas streams.

### BACKGROUND

Coal-fired power generation plants, municipal waste incinerators, and oil refinery plants generate large amounts of flue gases that contain substantial varieties and quantities of environmental pollutants, such as sulfur oxides (SO₂, and SO₃), nitrogen oxides (NO, NO₂), mercury (Hg) vapor, and particulate matters (PM). In the United States, burning coal alone generates about 27 million tons of SO₂ and 45 tons of Hg each year. Thus, there is a need for improvements to control systems and methods for removing sulfur oxides, mercury vapor, and fine particulate matters from industrial flue gases, such as coal-fired power plant flue gas.

### SUMMARY

In some embodiments, an improved durable pollution control system is provided that may simultaneously remove multiple flue gas pollutants. These pollutants may include, but are not limited to for example, SOₓ, Hg vapor, and PM2.5 (particulate matter having a diameter of 2.5 micrometers or less). Some embodiments may include a simple pollution control system which may not generate secondary pollutants. In some embodiments, a pollution control system that may provide a source of halogen in a required amount for a prolonged period of time. In particular, a flue gas treatment device may include a more durable and longer lasting halogen source in combination with a sorbent polymer composite substrate. In some embodiments, the sorbent polymer substrate may not get leached away in solutions developed in the treatment process.

Some embodiments of the present disclosure relate to articles having a layered structure, which can include a halogen source and an SPC. In some embodiments, the articles described herein can allow for delayed release of at least one halogen source from a halogen reservoir, which may form a part of the articles described herein.

In some embodiments, the article includes a flue gas treatment device. In some embodiments, the article is a flue gas treatment device. In some embodiments, the article is a part of a flue gas treatment device.

In some embodiments, an article comprises a first SPC layer; a second SPC layer; and a halogen reservoir, wherein the halogen reservoir is disposed between the first SPC layer and the second SPC layer.

In some embodiments, the article comprises or further comprises at least one permeation control material.

In some embodiments of the article, the at least one permeation control material is in a form of at least one permeation control layer, wherein the at least one permeation control layer is disposed between the first SPC layer and the halogen reservoir, between the second SPC layer and the halogen reservoir, or both. That is, in some embodiments of the article, the at least one permeation control material is in a form of at least one permeation control layer, wherein the at least one permeation control layer is disposed between the first SPC layer and the halogen reservoir, and also between the second SPC layer and the halogen reservoir.

In some embodiments of the article, the at least one permeation control layer comprises a first layer of the at least one permeation control material, wherein the first layer is disposed between the first SPC layer and the halogen reservoir; and a second layer of the at least one permeation control material, wherein the second layer is disposed between the second SPC layer and the halogen reservoir.

In some embodiments, an article comprises a sorbent polymer composite (SPC); and a plurality of halogen reservoirs, wherein the plurality of halogen reservoirs are embedded within the SPC, wherein each halogen reservoir of the plurality of halogen reservoirs comprises 5 wt % to 95 wt % of at least one permeation control material based on an average weight of each halogen reservoir, and 5 wt % to 50% of at least one halogen source based on an average weight of each halogen reservoir.

In some embodiments of the article, the SPC comprises a polymer material.

In some embodiments of the article, the polymer material includes at least one of polyfluoroethylene propylene (PFEP); polyperfluoroacrylate (PPFA); polyvinylidene fluoride (PVDF); a terpolymer of tetrafluoroethylene, hexafluoropropylene and vinylidene fluoride (THV); polychlorotrifluoro ethylene (PCFE); poly(ethylene-co-tetrafluorethylene) (ETFE); ultrahigh molecular weight polyethylene (UHMWPE); polyethylene; polyparaxylylene (PPX); polyactic acid (PLLA); polyethylene (PE); expanded polyethylene (ePE); polytetrafluoroethylene (PTFE); expanded polytetrafluoroethylene (ePTFE); or any combination thereof.

In some embodiments of the article, the polymer material includes PVDF.

In some embodiments of the article, the PVDF is a PVDF homopolymer.

In some embodiments of the article, the PVDF is a PVDF copolymer.

In some embodiments of the article, the PVDF copolymer is a copolymer of PVDF and hexafluoropropylene (HFP).

In some embodiments of the article, the polymer material includes PTFE.

In some embodiments of the article, the polymer material includes ePTFE.

In some embodiments of the article, the polymer material includes fibrils and nodes, wherein the polymer material becomes porous upon stretching, such that voids form between the fibrils and the nodes.

In some embodiments of the article, the at least one halogen source includes at least a metal halide, an ammonium halide, an elemental halogen, or any combination thereof.

In some embodiments of the article, the at least one halogen source includes at least sodium chloride, potassium chloride, sodium bromide, potassium bromide, sodium iodide, potassium iodide, or any combination thereof.

In some embodiments of the article, the at least one halogen source includes at least an ammonium halide.

In some embodiments of the article, the at least one halogen source includes at least tetramethylammonium iodide, tetrabutylammonium iodide, tetraethylammonium iodide, tetrapropylammonium iodide, tetramethylammonium bromide, tetraethylammonium bromide, tetrapropylammonium bromide, tetrabutylammonium bromide, tetrabutylammonium tri-iodide, tetrabutylammonium tri-bromide, tetramethylammonium chloride, tetraethylammonium chloride, tetrapropylammonium chloride, tetrabutylammonium chloride, or any combination thereof.

In some embodiments of the article, the at least one halogen source includes at least an elemental halogen.

In some embodiments of the article, the elemental halogen is at least one of elemental iodine (I₂), elemental chlorine (Cl₂), or elemental bromine (Br₂).

In some embodiments of the article, the at least one halogen source includes tetrabutylammonium iodide (TBAI).

In some embodiments of the article, the at least one halogen source includes potassium iodide (KI).

In some embodiments of the article, the at least one halogen source includes at least one phosphonium halide.

In some embodiments of the article, the at least one phosphonium halide comprises tetrabutylphosphonium iodide (TBPI), ethyltriphenylphosphonium triiodide (ETPPI₃), tetrabutylphosphonium bromide (TBPBr), ethyltriphenylphosphonium bromide (ETPPBr), ethyltriphenylphosphonium iodide (ETPPI), or any combination thereof. In some embodiments, the at least one phosphonium halide is selected from the group consisting of tetrabutylphosphonium iodide (TBPI), ethyltriphenylphosphonium triiodide (ETPPI₃), tetrabutyl phosphonium bromide (TBPBr), ethyltriphenylphosphonium bromide (ETPPBr), ethyltriphenylphosphonium iodide (ETPPI), or any combination thereof.

In some embodiments of the article, the at least one phosphonium halide is ETPPI.

In some embodiments of the article, the article comprises a sufficient quantity of the plurality of halogen reservoirs, so as to result in a release rate of total halogens from the article that does not exceed 0.5% of the total halogens in the article per day, under conditions where a flue gas stream is flowed over at least one surface of the article over a time period of at least 90 days; wherein the flue gas stream has a temperature of at least 50° C. and a relative humidity of at least 95%, and wherein the gas stream comprises at least one SOₓ compound in a concentration of at least 20 ppm, and mercury vapor in a concentration of at least 1 μg/m³ of the flue gas stream.

In some embodiments of the article, the article comprises a sufficient quantity of the plurality of halogen reservoirs, so as to result in a release rate of total halogens from the article that does not exceed 2% of the total halogens in the article per day, under conditions where a flue gas stream is flowed over at least one surface of the article over a time period of at least 90 days; wherein the flue gas stream has a temperature of at least 20° C. and a relative humidity of at least 95%, and wherein the gas stream comprises at least one SOₓ compound in a concentration of at least 1 ppm, and mercury vapor in a concentration of at least 1 μg/m³ of the flue gas stream.

In some embodiments of the article, at least one of the plurality of halogen reservoirs takes a form of an encapsulated bead, wherein the encapsulated bead comprises a core and the at least one halogen source, wherein the at least one halogen source is present at least on a surface of the core; and the permeation control material, wherein the permeation control material encapsulates the core.

In some embodiments of the article, the core comprises activated carbon.

In some embodiments of the article, at least one of the plurality of halogen reservoirs is in a form of a reservoir particle, wherein the reservoir particle comprises the permeation control material, wherein the permeation control material is in a form of a permeation control particle; and the at least one halogen source, wherein the at least one halogen source is present at least on a surface of the permeation control particle.

In some embodiments of the article, the permeation control material includes polystyrene, a cross-linked polystyrene-divinylbenzene (PS-DVB), or a combination thereof.

In some embodiments of the article, the reservoir particle further comprises a second permeation control material, wherein the second permeation control material surrounds the at least one halogen source on the surface of the permeation control particle.

In some embodiments of the article, the plurality of halogen reservoirs takes a form of a plurality of reservoir clusters, wherein each of the reservoir clusters comprises the at least one halogen source; and the permeation control material.

In some embodiments of the article, the plurality of reservoir clusters takes a form of a plurality of halogen reservoir pieces embedded throughout the SPC.

In some embodiments of the article, the plurality of reservoir clusters takes a form of a plurality of halogen reservoir agglomerates mixed with the SPC.

In some embodiments of the article, the sufficient quantity of the plurality of halogen reservoirs is 5 wt % to 75 wt % of the plurality of halogen reservoirs based on a total weight of the article.

In some embodiments of the article, the sufficient quantity of the plurality of halogen reservoirs is 5 wt % to 50 wt % of the plurality of halogen reservoirs based on a total weight of the article.

In some embodiments, a method comprises obtaining a sorbent polymer composite (SPC); and obtaining a plurality of halogen reservoirs, wherein each reservoir of the plurality of halogen reservoirs comprises: 5 wt % to 95 wt % of at least one permeation control material based on an average weight of each halogen reservoir, and 5 wt % to 50% of at least one halogen source by based on an average weight of each halogen reservoir; and forming article having the plurality of halogen reservoirs embedded within the SPC.

In some embodiments of the method, at least one of the plurality of halogen reservoirs takes a form of an encapsulated bead, wherein the method further comprises forming the encapsulated bead by obtaining at least one particle forming a core; depositing the at least one halogen source onto a surface of the at least one particle; and encapsulating the core with at least one permeation control material, so as to form the encapsulated bead.

In some embodiments of the method, the at least one halogen source is deposited as a solution onto the surface of the at least one particle.

In some embodiments of the method, the at least one halogen source is deposited in a gas phase onto the surface of the at least one particle.

In some embodiments of the method, the at least one particle is a carbon particle.

In some embodiments of the method, at least one of the plurality of halogen reservoirs is in a form of a reservoir particle, wherein the reservoir particle is formed by obtaining the at least one permeation control material in a form of a permeation control particle; and depositing the at least one halogen source onto a surface of the permeation control particle.

In some embodiments, the method further comprises, after depositing the at least one halogen source onto the surface of the permeation control particle, depositing a second permeation control material on at least a portion of the reservoir particle, so as to form a second permeation control layer that surrounds the at least one halogen source.

In some embodiments of the method, the plurality of halogen reservoirs is in a form of a plurality of reservoir clusters, wherein the method further comprises forming each of the plurality of reservoir clusters by mixing a plurality of particles with at least one halogen source and at least one permeation control material, so as to form a mixture; forming the mixture into films or parts; forming the films or parts into halogen reservoir pieces; and embedding the halogen reservoir pieces into the SPC.

In some embodiments of the method, the plurality of halogen reservoirs is in a form of a plurality of reservoir clusters, wherein the method further comprises forming each of the plurality of reservoir clusters by obtaining a SPC agglomerate; mixing a plurality of particles with at least one halogen source and at least one permeation control material to form a reservoir agglomerate; and mixing the SPC agglomerate with the reservoir agglomerate to form the article.

In some embodiments, the method, further comprises flowing a flue gas stream to contact the article, wherein the flue gas stream has a temperature of at least 50° C. and a relative humidity of at least 95%, wherein the flue gas stream comprises at least one SOₓ compound in a concentration of at least 20 ppm, and mercury vapor in a concentration of at least 1 μg/m³ based on a total volume of the flue gas stream, wherein a release rate of total halogens in the article does not exceed 0.5% of the total halogens in the article per day.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1A depicts a non-limiting embodiment of a sorbent polymer composite (SPC) described herein, in a cross-sectional view.

FIG. 1B depicts an additional non-limiting embodiment of a sorbent polymer composite (SPC) described herein.

FIGS. 2A-2F depict non-limiting embodiments of halogen reservoirs encapsulated by permeation control materials incorporated into a sorbent polymer composite (SPC), according to some embodiments of the disclosure.

FIG. 3A is an electron image that depicts a plurality of halogen reservoir particles in the form of coated iodine loaded particles, according to some non-limiting embodiments of the disclosure.

FIG. 3B is an electron image that depicts a sorbent polymer composite (SPC) comprising a plurality of reservoir particles in the form of coated iodine loaded particles, according to some non-limiting embodiments of the disclosure.

FIGS. 4A and 4B are electron images that depict a sorbent polymer composite (SPC) embedded with one or more halogen reservoir particles, according to some non-limiting embodiments of the disclosure.

FIG. 5A depicts an encapsulated bead according to some non-limiting embodiments of the present disclosure.

FIG. 5B is an electron image of a collection of encapsulated beads according to some embodiments of the disclosure.

FIG. 6A and FIG. 6B are a set of photographs of halogen reservoir clusters, according to some non-limiting embodiments of the disclosure.

FIG. 7 are graphs of relative iodine content versus time of some samples according to some embodiments of the disclosure.

FIG. 8 are graphs of relative iodine content versus time of some samples according to some embodiments of the disclosure.

FIG. 9 shows a graph of relative iodine content versus time, according to some comparative samples.

FIG. 10 shows a graph of relative iodine content versus time, according to some comparative samples.

FIG. 11 depicts a non-limiting embodiment of a pollution control system having any of the article(s) described herein.

FIG. 12 depicts a non-limiting embodiment showing a flue gas flowing over a non-limiting embodiment of the article(s) described herein.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

All prior patents and publications referenced herein are incorporated by reference in their entireties.

A sorbent polymer composite (SPC) has been proven to be particularly effective in removing undesirable components from a flue gas stream. Such undesirable components, may include, but are not limited to, at least one SOₓ compound and mercury vapor.

The use of at least one halogen source can enhance the removal efficiency of the SPC. However, in some cases, the at least one halogen source may not be sufficiently durable to allow for the SPC (and systems including the same, such as but not limited to, fixed bed absorbent systems) to remain in operation for multiple years. In some instances, this may occur because addition of the at least one halogen source may release away from the sorbent.

Accordingly, some embodiments of the present disclosure provide an exemplary solution whereby a plurality of halogen reservoirs allow the at least one halogen source to be released over time. The plurality of halogen reservoirs can allow the SPC (and systems including the same, such as but not limited to, fixed bed absorbent systems) to operate (e.g., be in service) over a longer period of time as compared to an SPC that does not include the plurality of halogen reservoirs.

As used herein, the term “sorbent” refers to a substance which has the property of collecting molecules of another substance by at least one of absorption, adsorption, or combinations thereof. The sorbent material of the sorbent polymer composite material includes at least one of: activated carbon, coal-derived carbon, lignite-derived carbon, wood-derived carbon, coconut-derived carbon, silica gel, zeolite, or any combination thereof.

As used herein, the term “composite” refers to a material including two or more constituent materials with different physical or chemical properties, whereby the combination of the two or more constituent materials results in a material with characteristics different from the individual components.

As used herein, a “sorbent polymer composite” (SPC) is a composite that includes a sorbent and a polymer. In embodiments the sorbent polymer composite may comprise sorbent particles that are incorporated into a microstructure of a polymer.

The sorbent polymer composite material further includes a halogen source. In some embodiments, the halogen source may be incorporated into the sorbent polymer composite material by any suitable technique which may include, but is not limited to, imbibing, impregnating, adsorbing, mixing, sprinkling, spraying, dipping, painting, coating, ion exchanging or otherwise applying the halogen source to the sorbent polymer composite material. In some embodiments, the halogen source may be located within the sorbent polymer composite material, such as within any porosity of the sorbent polymer composite material. In some embodiments, the halogen source may be provided in a solution which may, under system operation conditions, in situ contact the sorbent polymer composite material. The halogen source of the sorbent polymer composite is a halogen salt, an elemental halogen, or any combination thereof. In some embodiments, the halogen source is chosen from at least one of sodium chloride, potassium chloride, sodium bromide, potassium bromide, sodium iodide, potassium iodide, tetramethylammonium iodide, tetrabutylammonium iodide, tetraethylammonium iodide, tetrapropylammonium iodide, tetramethylammonium bromide, tetraethylammonium bromide, tetrapropylammonium bromide, tetrabutylammonium bromide, tetramethylammonium chloride, tetraethylammonium chloride, tetrapropylammonium chloride, tetrabutylammonium chloride, elemental iodine (I₂), elemental chlorine (Cl₂), elemental bromine (Br₂), or any combination thereof. Additional configurations of the sorbent polymer composite described herein and additional examples of the halogen sources described herein are set out in U.S. Pat. No. 9,827,551 (1368) to Hardwick et al and U.S. Pat. No. 7,442,352 to Lu et al, each of which are incorporated by reference herein in their entireties.

As used herein, the term “reservoir” refers to a repository that houses at least one material, whereby the repository is configured to release the at least one material over a period of time. In some non-limiting embodiments, the repository may comprise the permeation control material.

As used herein, the term “halogen reservoir” refers to a reservoir comprising at least one halogen source, where the at least one halogen source is configured to be released from the repository over a period of time.

As used herein “embedded” means that a first material is distributed throughout a second material.

As used herein, the term “permeation control material” refers to a material that is configured to release one or more substances from the reservoir at a slower rate than the substance would have been released without the permeation control layer being present.

As used herein, the term “halogen source” refers to any chemical compound comprising at least one halide ion or an elemental halogen. The halogen source of a flue gas treatment device is selected from tetrabutylammonium iodide, tetrabutylammonium tri-iodide, tetrabutylammonium tri-bromide, or tetrabutylammonium bromide. In another embodiment, the halogen source is a compound with a formula: N(R1 R2R3R4)X, where N is nitrogen and X═I⁻, Br⁻, I₃⁻, BrI₂⁻, Br₂I⁻, Br₃⁻ and where R1, R2, R3 and R4 are selected from the group consisting of a hydrocarbon having from about 1 to about 18 carbon atoms where the hydrocarbon may be a simple alkyl, including but not limited to, linear or branched alkyl. The halogen source may comprise a tri-halide where the tri-halide is formed from its halide precursor by acid treatment in the presence of an oxidizer. In a further embodiment, the halogen source is a tri-halide where the tri-halide is formed from its halide precursor by acid treatment in the presence of an oxidizer selected from the group consisting of hydrogen peroxide, alkali metal persulfate, alkali metal monopersulfate, potassium iodate, potassium monopersulfates, oxygen, iron (III) salts, iron (III) nitrate iron (III) sulfate, iron (III) oxide and combinations thereof.

As used herein, an “average weight of each halogen reservoir” is calculated by summing a weight of each of the plurality of halogen reservoirs in a particular article and then dividing the resultant sum of weights by a total weight of the article.

As used herein, “release rate of total halogens” is a release rate, from the article, into the external environment where the article is present, of the at least one halogen source. In some non-limiting embodiments, the external environment may be a flue gas stream. In some embodiments, the at least one halogen source is released solely from the sorbent polymer composite (SPC), into the external environment. In these embodiments, the “release rate of total halogens” is the release rate from the sorbent polymer composite (SPC) into the external environment. In some embodiments, the at least one halogen source is released solely from the plurality of halogen reservoirs into the external environment. In these embodiments, the “release rate of total halogens” is the release rate from the plurality of halogen reservoirs into the external environment. In some embodiments, the at least one halogen source is released from a combination of the sorbent polymer composite (SPC) and the plurality of halogen reservoirs into the external environment. In these embodiments, the “release rate of total halogens” is a combined release rate, which accounts for the release of the at least one halogen source from both the sorbent polymer composite (SPC) and the plurality of halogen reservoirs. In some embodiments, the article comprises a plurality of halogen sources. In these embodiments, the “release rate of total halogens” is a combined release rate, which accounts the release of all of the plurality of halogen sources in the article. The determination of the release rate is further explained below.

As used herein, the term “flue gas stream” refers to a gaseous mixture that comprises at least one byproduct of a combustion process (such as, but not limited to, a coal combustion process). In some embodiments, a flue gas stream may consist entirely of byproducts of a combustion process. In some embodiments, a flue gas stream may include at least one gas in an elevated concentration relative to a concentration resulting from the combustion process. For instance, in one non-limiting example, a flue gas stream may be subjected to a “scrubbing” process during which water vapor may be added to the flue gas stream. Accordingly, in some such embodiments, the flue gas stream may include water vapor in an elevated concentration relative to the initial water vapor concentration due to combustion. Similarly, in some embodiments, a flue gas stream may include at least one gas in a lesser concentration relative to an initial concentration of the at least one gas output from the combustion process. This may occur, for example, by removing at least a portion at least one gas after combustion. In some embodiments, a flue gas stream may take the form of a gaseous mixture that is a combination of byproducts of multiple combustion processes.

As used herein, the term a “SOₓ compound” refers to any oxide of sulfur. In some nonlimiting embodiments, “SOₓ compound” may specifically refer to gaseous oxides of sulfur that are known environmental pollutants. Non-limiting examples of SOₓ compounds include sulfur dioxide (SO₂) and sulfur trioxide (SO₃). Additional non-limiting examples of SOₓ compounds include sulfur monoxide (SO), disulfur monoxide (S₂O), and disulfur dioxide (S₂O₂).

As used herein, the term “mercury vapor” refers to a gaseous compound comprising mercury. Nonlimiting examples of mercury vapor include elemental mercury vapor and oxidized mercury vapor.

As used herein, the term “oxidized mercury vapor” is defined as a vapor-phase mercury compound that includes mercury in a positive valence state. Non-limiting examples of oxidized mercury vapor include mercurous halides and mercuric halides.

Various terms are used herein to describe forms of halogen reservoirs. These forms generally describe reservoirs of halogens that are localized volumes of matter, i.e., localized volumes of halogens or a localized concentration of halogens. The terms, encapsulated beads, particles, clusters, agglomerates, and streaks, all describe various forms of volumetrically localized groups of halogens. As an example, beads can be substantially spherical, having uniformly smooth outer surface, or non-uniformly smooth (i.e., bumpy) outer surface. Beads can be regular or non-regular in shape or form. As another example, particles can have irregular shapes, sizes, or both. Particles and pieces generally are generally not uniformly spherical or generally have a uniformly smooth surface. Particles and pieces can be irregularly distributed within something. In some embodiments, a particular form of volumetrically localized halogen can be described as being any one or more of these forms.

As used herein, the term “encapsulated bead” refers to a halogen reservoir in the form of a bead that comprises a core and at least one encapsulant that surrounds the core. At least one halogen source is present on at least on a surface of the core. The core may comprise carbon, for example activated carbon. In some embodiments, the at least one encapsulant may comprise the permeation control material.

As used herein, the term “reservoir particle” refers to a halogen reservoir in the form of a particle. In some embodiments, a “reservoir particle” may comprise at least one permeation control material and at least one halogen source as described herein. Some non-limiting examples of a “reservoir particle” include, but are not limited to, reservoir pieces, reservoir agglomerates, iodine loaded beads, and some embodiments of encapsulated beads. At least one specific non-limiting example of a reservoir piece is described in detail in Example 1. At least one specific non-limiting example of a reservoir agglomerate is described in detail in Example 1. At least one specific non-limiting example of encapsulated beads is described in detail in Example 2. At least one specific non-limiting example of iodine loaded beads or particles is described in detail in Example 3.

As used herein, the term “reservoir cluster” refers to a cluster of halogen reservoirs in the form of streaks or groupings of irregular shapes.

As used herein, a “reservoir agglomerate” is a collection or mass of reservoir clusters. In some embodiments, each “reservoir agglomerate,” (i.e., each the collection or mass of reservoir clusters) may be localized within at least one specific region of the SPC.

As used herein, the term “agglomerated mixture” refers to a mixture, where the components of the mixture are clustered together.

As used herein a “carbon particle” is any particle comprising carbon.

As used herein, a “porous carbon particle” refers to carbon particle having pores, and does not include carbon particles without pores. That is, porous carbon particle excludes “non-porous” carbon particles.

As used herein, the term “permeation control particle” refers to at least one permeation control material in the form of a particle.

Some embodiments of the present disclosure relate to an article comprising a sorbent polymer composite (SPC), and a plurality of halogen reservoirs.

In some embodiments, the sorbent polymer composite (SPC) can include one or more homopolymers, copolymers or terpolymers containing at least one fluoromonomer with or without additional non-fluorinated monomers.

In some embodiments, the polymer material of the sorbent polymer composite (SPC) can include at least one of: polyfluoroethylene propylene (PFEP); polyperfluoroacrylate (PPFA); polyvinylidene fluoride (PVDF); a terpolymer of tetrafluoroethylene, hexafluoropropylene and vinylidene fluoride (THV); polychlorotrifluoro ethylene (PCFE); poly(ethylene-co-tetrafluorethylene) (ETFE); ultrahigh molecular weight polyethylene (UHMWPE); polyethylene; polyparaxylylene (PPX); polyactic acid (PLLA); polyethylene (PE); expanded polyethylene (ePE); polytetrafluoroethylene (PTFE); expanded polytetrafluoroethylene (ePTFE); or any combination thereof.

In some embodiments, the polymer material of the sorbent polymer composite (SPC) can include polyvinylidene fluoride (PVDF). In some embodiments, the PVDF may be a PVDF homopolymer. In some embodiments, the PVDF may be a PVDF copolymer. In some embodiments, the PVDF copolymer is a copolymer of PVDF and hexafluoropropylene (HFP). Non-limiting commercial examples of PVDF homopolymers or copolymers that may be suitable for some embodiments of the present disclosure, include but are not limited to Kynar Flex® and Kynar Superflex®, each of which is commercially available from the company Arkema.

In some embodiments, the polymer material of the sorbent polymer composite (SPC) can include polytetrafluoroethylene (PTFE). In some embodiments, the polymer is expanded polytetrafluoroethylene (ePTFE). In some embodiments, the structure of the polymer can become porous upon stretching, such that voids can form between fibrils and nodes of the polymer.

In some embodiments, the sorbent polymer composite (SPC) has a thickness ranging from 0.2 mm to 2 mm, from 0.4 mm to 2 mm, from 0.8 mm to 2 mm, from 1.2 mm to 2 mm or from 1.6 mm to 2 mm. In some embodiments, the sorbent polymer composite (SPC) has a thickness ranging from 0.2 mm to 1.6 mm, from 0.2 mm to 1.2 mm, from 0.2 mm to 0.8 mm or from 0.2 mm to 0.4 mm. In some embodiments, the sorbent polymer composite (SPC) has a thickness ranging from 0.4 mm to 1.6 mm or from 0.8 mm to 1.2 mm. In some embodiments, the thickness of the sorbent polymer composite (SPC) may be measured using cross section scanning electron microscopy.

In some embodiments, the polymer of the sorbent polymer composite (SPC) has a surface energy of less than 31 dynes per cm, of less than 30 dynes per cm, of less than 25 dynes per cm, of less than 20 dynes per cm or of less than 15 dynes per cm.

In some embodiments, the polymer of the sorbent polymer composite (SPC) has a surface energy ranging from 15 dynes per cm to 31 dynes per cm, from 20 dynes per cm to 31 dynes per cm, from 25 dynes per cm to 31 dynes per cm, from 30 dynes per cm to 31 dynes per cm, from 15 dynes per cm to 30 dynes per cm, from 15 dynes per cm to 25 dynes per cm or from 15 dynes per cm to 20 dynes per cm.

In some embodiments, the polymer of the sorbent polymer composite (SPC) has a surface energy ranging from 20 dynes per cm to 25 dynes per cm.

In some embodiments, an SPC includes a sorbent. In some embodiments, the sorbent of the SPC comprises activated carbon. In some embodiments, the sorbent comprises activated carbon derived from coal, lignite, wood, coconut shells, another carbonaceous material, or any combination thereof. In some embodiments, the sorbent can include silica gel, a zeolite, or any combination thereof.

In some embodiments, the sorbent of the sorbent polymer composite (SPC) has a surface area in excess of 400 m²/g, in excess of 600 m²/g, in excess of 800 m²/g, in excess of 1000 m²/g, in excess of 1200 m²/g, in excess of 1400 m²/g, in excess of 1600 m²/g, in excess of 1800 m²/g or in excess of 2000 m²/g.

In some embodiments, the sorbent of the sorbent polymer composite (SPC) has a surface area ranging from 400 m²/g to 2000 m²/g, from 600 m²/g to 2000 m²/g, from 800 m²/g to 2000 m²/g, from 1000 m²/g to 2000 m²/g, from 1200 m²/g to 2000 m²/g, from 1400 m²/g to 2000 m²/g, from 1600 m²/g to 2000 m²/g or from 1800 m²/g to 2000 m²/g.

In some embodiments, the sorbent of the sorbent polymer composite (SPC) has a surface area ranging from 400 m²/g to 1800 m²/g, from 400 m²/g to 1600 m²/g, from 400 m²/g to 1400 m²/g, from 400 m²/g to 1200 m²/g, from 400 m²/g to 1000 m²/g, from 400 m²/g to 800 m²/g or from 400 m²/g to 600 m²/g.

In some embodiments, the sorbent of the sorbent polymer composite (SPC) has a surface area ranging from 600 m²/g to 1800 m²/g, from 800 m²/g to 1600 m²/g or from 1000 m²/g to 1400 m²/g.

In some embodiments, the at least one halogen source of the sorbent polymer composite (SPC) comprises a metal halide, an ammonium halide, an elemental halogen, or any combination thereof. In some embodiments, the at least one halogen source of the sorbent polymer composite (SPC) comprises a metal halide. In some embodiments, the at least one halogen source of the sorbent polymer composite (SPC) is chosen from at least one of sodium chloride, potassium chloride, sodium bromide, potassium bromide, sodium iodide, or potassium iodide. In some embodiments, the at least one halogen source of the sorbent polymer composite (SPC) comprises an ammonium halide. In some embodiments, the at least one halogen source of the sorbent polymer composite (SPC) is chosen from at least one of tetramethylammonium iodide, tetrabutylammonium iodide, tetraethylammonium iodide, tetrapropylammonium iodide, tetramethylammonium bromide, tetraethylammonium bromide, tetrapropylammonium bromide, tetrabutylammonium bromide, tetrabutylammonium tri-iodide, tetrabutylammonium tri-bromide, tetramethylammonium chloride, tetraethylammonium chloride, tetrapropylammonium chloride, or tetrabutylammonium chloride. In some embodiments, the at least one halogen source of the sorbent polymer composite (SPC) comprises elemental halogen. In some embodiments, the at least one halogen source of the sorbent polymer composite (SPC) is chosen from at least one of elemental iodine (I₂), elemental chlorine (Cl₂), or elemental bromine (Br₂).

In some embodiments, the at least one halogen source of the sorbent polymer composite (SPC) is elemental iodine (I₂). In some embodiments, the at least one halogen source of the sorbent polymer composite (SPC) is tetrabutylammonium iodide (TBAI). In some embodiments, the at least one halogen source of the sorbent polymer composite (SPC) is potassium iodide (KI).

In some embodiments, the at least one halogen source of the sorbent polymer composite (SPC) comprises at least one phosphonium halide.

In some embodiments, the at least one phosphonium halide comprises tetrabutylphosphonium iodide (TBPI), ethyltriphenylphosphonium triiodide (ETPPI₃), tetrabutylphosphonium bromide (TBPBr), ethyltriphenylphosphonium bromide (ETPPBr), ethyltriphenylphosphonium iodide (ETPPI), or any combination thereof. In some embodiments, the at least one phosphonium halide is selected from the group consisting of tetrabutylphosphonium iodide (TBPI), ethyltriphenylphosphonium triiodide (ETPPI₃), tetrabutyl phosphonium bromide (TBPBr), ethyltriphenylphosphonium bromide (ETPPBr), ethyltriphenylphosphonium iodide (ETPPI), or any combination thereof.

In some embodiments, the at least one phosphonium halide comprises tetrabutylphosphonium iodide (TBPI), ethyltriphenylphosphonium triiodide (ETPPI₃), tetrabutylphosphonium bromide (TBPBr), ethyltriphenylphosphonium bromide (ETPPBr), or any combination thereof. In some embodiments, the at least one phosphonium halide is selected from the group consisting of tetrabutylphosphonium iodide (TBPI), ethyltriphenylphosphonium triiodide (ETPPI₃), tetrabutylphosphonium bromide (TBPBr), ethyltriphenylphosphonium bromide (ETPPBr), or any combination thereof.

In some embodiments, the at least one phosphonium halide is ethyltriphenylphosphonium iodide (ETPPI).

In some embodiments, the at least one halogen source may be incorporated into the sorbent polymer composite (SPC) by any suitable technique which may include, but is not limited to, imbibing, impregnating, adsorbing, mixing, sprinkling, spraying, dipping, painting, coating, ion exchanging or otherwise applying the at least one halogen source to the sorbent polymer composite (SPC). In some embodiments, the at least one halogen source may be located within the sorbent polymer composite (SPC), such as within any porosity of the sorbent polymer composite (SPC). In some embodiments, the at least one halogen source may be provided in a solution which may, under system operation conditions, in situ contact the sorbent polymer composite (SPC).

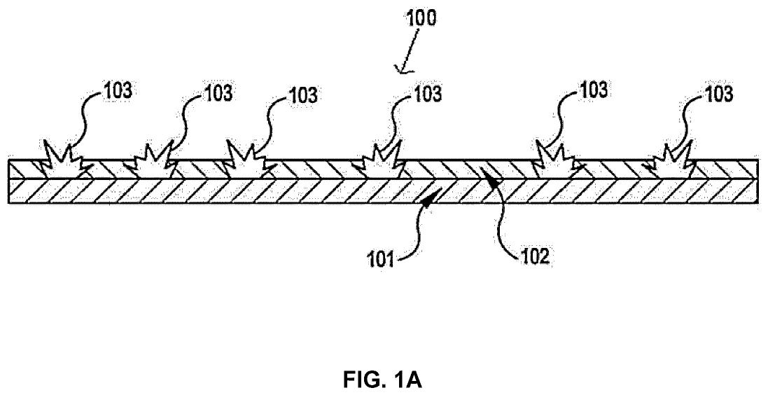

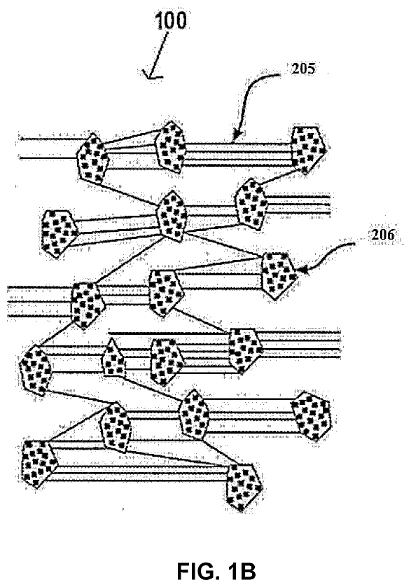

FIG. 1A depicts a non-limiting embodiment of a sorbent polymer composite (SPC) 100 described herein, in a cross-sectional view. In this non-limiting embodiment, the sorbent polymer composite (SPC) 100 includes a sorbent 102 that partially or completely covers a polymer 101. In some non-limiting embodiments, at least one halogen source 103 (as described herein) can partially or completely cover portions of the sorbent 102. In some embodiments, the at least one halogen source 103 may be imbibed into pores of the sorbent 102.

FIG. 1B depicts an additional a non-limiting embodiment of a sorbent polymer composite (SPC) 100 described herein. As shown, sorbent polymer composite (SPC) 100 may comprise sorbent particles 206 that are incorporated into a microstructure 205 of a polymer. In some embodiments, the particles 206 may be activated carbon particles. In some embodiments, the microstructure 205 of the polymer may comprise fibrils. In some embodiments, the polymer may be expanded PTFE.

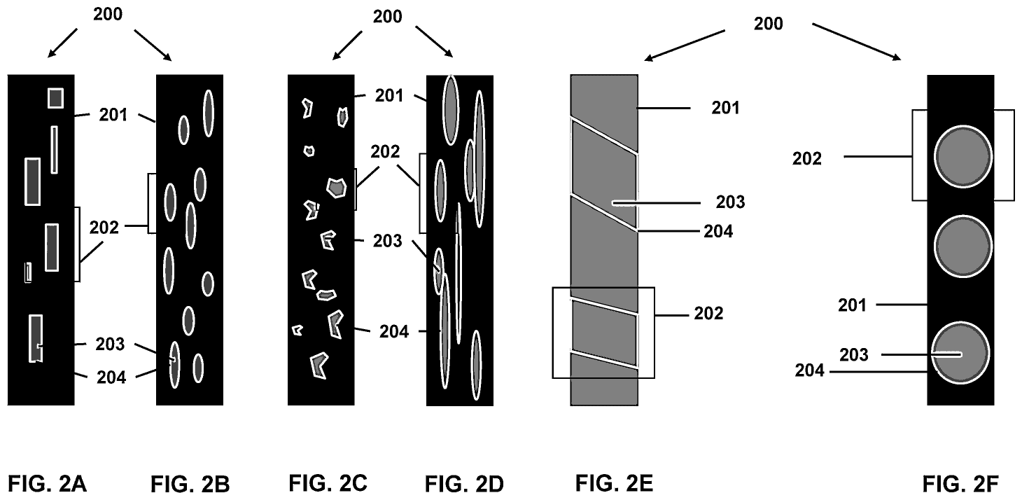

In some embodiments, each halogen reservoir of the plurality of halogen reservoirs is embedded within the sorbent polymer composite (SPC). FIGS. 2A-2F are simplified illustrations of halogen reservoirs incorporated into a sorbent polymer composite (SPC), according to some non-limiting embodiments of the present disclosure. In the non-limiting embodiments of FIGS. 2A to 2F, the article 200 may comprise a sorbent polymer composite (SPC) 201 and may further comprise a plurality of halogen reservoirs 202 embedded within the sorbent polymer composite (SPC) 201. As further shown, the plurality of halogen reservoirs 202 may comprise at least one halogen source 203 and at least one permeation control material 204 as described herein. As further depicted in FIGS. 2A to 2F, the plurality of halogen reservoirs 202 may take the form of a plurality of halogen reservoir clusters.

For example, as shown in the non-limiting embodiment shown in FIG. 2A, the plurality of halogen reservoirs 202 in the form of the plurality of reservoir clusters may take the form of “rectangular reservoir pieces” made of for example halogen reservoir films or parts as further described in example 1.

For example, as shown in the non-limiting embodiment shown in FIG. 2B, the plurality of halogen reservoirs 202 in the form of the plurality of reservoir clusters may take the form of “elliptical reservoir pieces.”

For example, as shown in the non-limiting embodiment shown in FIG. 2C, the plurality of halogen reservoirs 202 in the form of the plurality of reservoir clusters may take the form of “irregular reservoir pieces.”

For example, as shown in the non-limiting embodiment shown in FIG. 2D, the plurality of halogen reservoirs 202 in the form of the plurality of reservoir clusters may take the form of “nodular reservoir pieces.”

As shown in the non-limiting embodiment shown, in FIG. 2E, an article 200 according to some embodiments of the present disclosure may comprise an SPC 201. The SPC 201 may further comprise a plurality of halogen reservoirs 202 embedded within the SPC 201. As further shown, the plurality of halogen reservoirs 202 may comprise a mixture of at least one halogen source 203 and at least one permeation control material 204 as described herein. As further described, the plurality of halogen reservoirs 202 may take the form of a plurality of reservoir clusters.

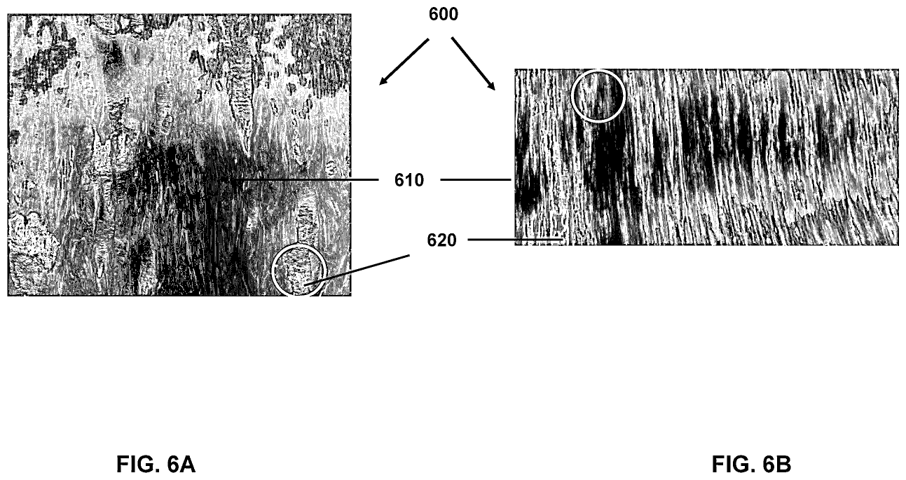

In some embodiments, the reservoir clusters may may coalesce to take the form, of streaks, such as in the non-limiting example of FIG. 6B.

In some embodiments, the plurality of halogen reservoirs 202 in the form of the plurality of reservoir agglomerates, may encompass a full thickness of the article, as is shown in the non-limiting embodiment of FIG. 2E. In some embodiments a thickness of the plurality of reservoir agglomerates may be equal to a thickness of the SPC 201.

As shown in the non-limiting embodiment shown in FIG. 2F, the plurality of halogen reservoirs 202 in the form of the plurality of reservoir clusters may take the form of “circular reservoir particles.”

In some embodiments, the reservoir clusters have at least one dimension ranging from 0.1 mm to 100 mm. For example, in some embodiments, the at least one dimension may refer to length, width, height, at least one radius, at perimeter, arc-length, contour length, or any combination thereof.

In some embodiments, the reservoir clusters have at least one dimension of 0.1 mm, at least one dimension of 0.2 mm, at least one dimension of 0.3 mm, at least one dimension of 0.4 mm, at least one dimension of 0.5 mm, at least one dimension of 0.6 mm, at least one dimension of 0.7 mm, at least one dimension of 0.8 mm, at least one dimension of 0.9 mm, at least one dimension of 1 mm, at least one dimension of 5 mm, at least one dimension of 10 mm, at least one dimension of 15 mm, at least one dimension of 20 mm, at least one dimension of 25 mm, at least one dimension of a 30 mm, at least one dimension of 35 mm, at least one dimension of 40 mm, at least one dimension of 45 mm, at least one dimension of 50 mm, at least one dimension of 55 mm, at least one dimension of 60 mm, at least one dimension of 65 mm, at least one dimension of 70 mm, at least one dimension of 75 mm, at least one dimension of 80 mm, at least one dimension of 85 mm, at least one dimension of 90 mm, at least one dimension of 95 mm or at least one dimension of 100 mm.

In some embodiments, the reservoir clusters have at least one dimension ranging from 0.2 mm to 100 mm, from 0.3 mm to 100 mm, from 0.4 mm to 100 mm, from 0.5 mm to 100 mm, from 0.6 mm to 100 mm, from 0.7 mm to 100 mm, from 0.8 mm to 100 mm, from 0.9 mm to 100 mm, from 1 mm to 100 mm, from 5 mm to 100 mm, from 10 mm to 100 mm, from 15 mm to 100, from 20 mm to 100 mm, from 25 mm to 100 mm, from 30 mm to 100 mm, from 35 mm to 100 mm, from 40 mm to 100 mm, from 45 mm to 100 mm, from 50 mm to 100 mm, from 55 mm to 100 mm, from 60 mm to 100 mm, from 65 mm to 100 mm, from 70 mm to 100 mm, from 75 mm to 100 mm, from 80 mm to 100 mm, from 85 mm to 100 mm, from 90 mm to 100 mm or from 95 mm to 100 mm.

In some embodiments, the reservoir clusters have at least one dimension ranging from 0.1 mm to 95 mm, from 0.1 mm to 90 mm, from 0.1 mm to 85 mm, from 0.1 mm to 80 mm, from 0.1 mm to 75 mm, from 0.1 mm to 70 mm, from 0.1 mm to 65 mm, from 0.1 mm to 60 mm, from 0.1 mm to 55 mm, from 0.1 mm to 50 mm, from 0.1 mm to 45 mm, from 0.1 mm to 40 mm, from 0.1 mm to 35 mm, from 0.1 mm to 30 mm, from 0.1 mm to 25 mm, from 0.1 mm to 20 mm, from 0.1 mm to 15 mm, from 0.1 mm to 10 mm, from 0.1 mm to 5 mm, from 0.1 mm to 1 mm. In some embodiments, the reservoir clusters have at least one dimension ranging from 0.1 mm to 0.9 mm, 0.1 mm to 0.8 mm, from 0.1 mm to 0.7 mm, from 0.1 mm to 0.6 mm, from 0.1 mm to 0.5 mm, from 0.1 mm to 0.4 mm, from 0.1 mm to 0.3 mm or from 0.1 mm to 0.2 mm.

In some embodiments, each halogen reservoir of the plurality of halogen reservoirs comprises at least one permeation control material. In some embodiments, the permeation control material comprises polycarbonate (PC), ethyl cellulose (EC), polystyrene (PS), polystyrene-divinylbenzene (PS-DVB), at least one polyolefin, at least one polyvinylidene fluoride (PVDF) homopolymer or copolymer, or any combination thereof.

In some embodiments, the PVDF copolymer is a copolymer of PVDF and hexafluoropropylene (HFP). Non-limiting commercial examples of PVDF homopolymers or copolymers that may be suitable for some embodiments of the present disclosure, include but are not limited to Kynar Flex® and Kynar Superflex®, each of which is commercially available from the company Arkema.

In some embodiments, the permeation control material comprises a polyethylene wax. In some embodiments, the permeation control material comprises a polypropylene wax.

In some embodiments, each halogen reservoir of the plurality of halogen reservoirs comprises 5 wt % to 95 wt % of at least one permeation control material based on an average weight of each halogen reservoir.

In some embodiments, each halogen reservoir of the plurality of halogen reservoirs comprises 5 wt % of at least one permeation control material based on an average weight of each halogen reservoir. In some embodiments, each halogen reservoir of the plurality of halogen reservoirs comprises 10 wt % of at least one permeation control material, 15 wt % of at least one permeation control material, 20 wt % of at least one permeation control material, 25 wt % of at least one permeation control material, 30 wt % of at least one permeation control material, 35 wt % of at least one permeation control material, 40 wt % of at least one permeation control material, 45 wt % of at least one permeation control material, 50 wt % of at least one permeation control material, 55 wt % of at least one permeation control material, 60 wt % of at least one permeation control material, 65 wt % of at least one permeation control material, 70 wt % of at least one permeation control material, 75 wt % of at least one permeation control material, 80 wt % of at least one permeation control material, 85 wt % of at least one permeation control material, 90 wt % of at least one permeation control material, 95 wt % of at least one permeation control material based on an average weight of each halogen reservoir.

In some embodiments, each halogen reservoir of the plurality of halogen reservoirs comprises 10 wt % to 95 wt % of at least one permeation control material, 15 wt % to 95 wt % of at least one permeation control material, 20 wt % to 95 wt % of at least one permeation control material, 25 wt % to 95 wt % of at least one permeation control material, 30 wt % to 95 wt % of at least one permeation control material, 35 wt % to 95 wt % of at least one permeation control material, 40 wt % to 95 wt % of at least one permeation control material, 45 wt % to 95 wt % of at least one permeation control material, 50 wt % to 95 wt % of at least one permeation control material, 55 wt % to 95 wt % of at least one permeation control material, 60 wt % to 95 wt % of at least one permeation control material, 65 wt % to 95 wt % of at least one permeation control material, 70 wt % to 95 wt % of at least one permeation control material, 75 wt % to 95 wt % of at least one permeation control material, 80 wt % to 95 wt % of at least one permeation control material, 85 wt % to 95 wt % of at least one permeation control material or 90 wt % to 95 wt % of at least one permeation control material based on an average weight of each halogen reservoir.

In some embodiments, each halogen reservoir of the plurality of halogen reservoirs comprises 5 wt % to 10 wt % of at least one permeation control material, 5 wt % to 15 wt % of at least one permeation control material, 5 wt % to 20 wt % of at least one permeation control material, 5 wt % to 25 wt % of at least one permeation control material, 5 wt % to 30 wt % of at least one permeation control material, 5 wt % to 35 wt % of at least one permeation control material, 5 wt % to 40 wt % of at least one permeation control material, 5 wt % to 45 wt % of at least one permeation control material, 5 wt % to 50 wt % of at least one permeation control material, 5 wt % to 55 wt % of at least one permeation control material, 5 wt % to 60 wt % of at least one permeation control material, 5 wt % to 65 wt % of at least one permeation control material, 5 wt % to 70 wt % of at least one permeation control material, 5 wt % to 75 wt % of at least one permeation control material, 5 wt % to 80 wt % of at least one permeation control material, 5 wt % to 85 wt % of at least one permeation control material or 5 wt % to 90 wt % of at least one permeation control material based on an average weight of each halogen reservoir.

In some embodiments, each halogen reservoir of the plurality of halogen reservoirs comprises at least one halogen source based on an average weight of each halogen reservoir. In some embodiments, each halogen reservoir of the plurality of halogen reservoirs comprises 5 wt % to 50 wt % of at least one halogen source based on an average weight of each halogen reservoir.

In some embodiments, each halogen reservoir of the plurality of halogen reservoirs comprises 5 wt % of at least one halogen source, 10 wt % of at least one halogen source, 15 wt % of at least one halogen source, 20 wt % of at least one halogen source, 25 wt % of at least one halogen source, 30 wt % of at least one halogen source, 35 wt % of at least one halogen source, 40 wt % of at least one halogen source, 45 wt % of at least one halogen source or 50 wt % of at least one halogen source based on an average weight of each halogen reservoir.

In some embodiments, each halogen reservoir of the plurality of halogen reservoirs comprises 10 wt % to 50 wt % of at least one halogen source based on an average weight of each halogen reservoir. In some embodiments, each halogen reservoir of the plurality of halogen reservoirs comprises 15 wt % to 50 wt % of at least one halogen source, 20 wt % to 50 wt % of at least one halogen source, 25 wt % to 50 wt % of at least one halogen, 30 wt % to 50 wt % of at least one halogen source, 35 wt % to 50 wt % of at least one halogen source, 40 wt % to 50 wt % of at least one halogen or 45 wt % to 50 wt % of at least one halogen source based on an average weight of each halogen reservoir.

In some embodiments, each halogen reservoir of the plurality of halogen reservoirs comprises 5 wt % to 45 wt % of at least one halogen source based on an average weight of each halogen reservoir. In some embodiments, each halogen reservoir of the plurality of halogen reservoirs comprises 5 wt % to 40 wt % of at least one halogen source, 5 wt % to 35 wt % of at least one halogen source, 5 wt % to 30 wt % of at least one halogen source, 5 wt % to 25 wt % of at least one halogen source, 5 wt % to 20 wt % of at least one halogen source, 5 wt % to 15 wt % of at least one halogen source, or 5 wt % to 10 wt % of at least one halogen source based on an average weight of each halogen reservoir.

In some embodiments, the at least one halogen source of the plurality of the halogen reservoirs may be any halogen source described herein. In some embodiments, the at least one halogen source of the plurality of the halogen reservoirs is the same as the at least one halogen source of the sorbent polymer composite (SPC). In some embodiments, the at least one halogen source of the plurality of the halogen reservoirs is different from the at least one halogen source of the sorbent polymer composite (SPC).

In some embodiments, the article comprises a sufficient quantity of the plurality of halogen reservoirs, so as to result in a release rate of total halogens from the article that does not exceed a specified amount of total halogens in the article per day, under conditions where a flue gas stream is flowed over at least one surface of the article over a time period of at least 90 days.

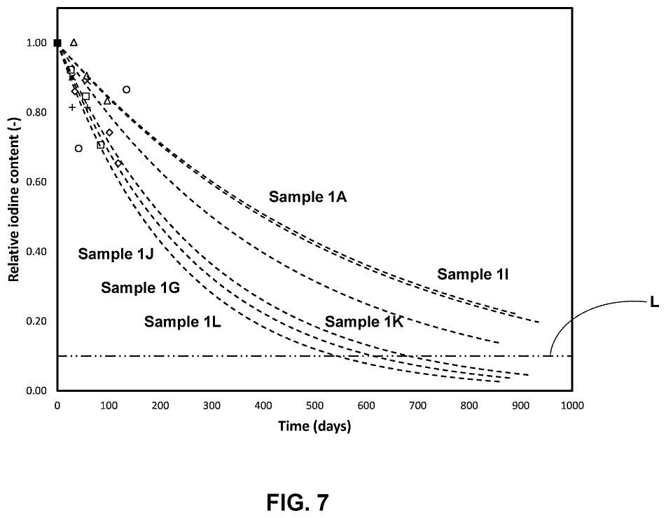

As described herein, the % per day refers to the amount of halogen relative to the total halogen content present at that time (not relative to the initial content), not relative to the weight of the SPC. In some embodiments, the decrease of the iodine content (or release rate) is exponential (i.e., the decrease can be described to be an exponential decay) as shown, for example, in FIGS. 7 to 10A, as discussed further herein. Accordingly, a constant “k” can be used to describe this behavior, wherein “k” can be called a “release rate constant,” a “decay constant,” or an “exponential decay constant.”

In some embodiments, a release rate of total halogens from the article does not exceed 0.1% of total halogens per day, does not exceed 0.2% of total halogens per day, does not exceed 0.3% of total halogens per day, does not exceed 0.4% of total halogens per day, does not exceed 0.5% of total halogens per day, does not exceed 0.6% of total halogens per day, does not exceed 0.7% of total halogens per day, does not exceed 0.8% of total halogens per day, does not exceed 0.9% of total halogens per day, does not exceed 1% of total halogens per day, does not exceed 1.5% of total halogens per day, does not exceed 2% of total halogens per day, does not exceed 2.5% of total halogens per day, does not exceed 3% of total halogens per day, does not exceed 4% of total halogens per day, does not exceed 5% of total halogens per day upon flowing of a flue gas stream over at least one surface of the article over a time period of at least 90 days.

In some embodiments, a release rate of total halogens from the article ranges from 0.1% to 2% of total halogens per day upon flowing of a flue gas stream over at least one surface of the article over a time period of at least 90 days. In some embodiments, a release rate of total halogens from the article ranges from 0.2% to 2% of total halogens per day, from 0.3% to 2% of total halogens per day, from 0.4% to 2% of total halogens per day, from 0.5% to 2% of total halogens per day, from 0.6% to 2% of total halogens per day, from 0.7% to 2% of total halogens per day, 0.8% to 1% of total halogens per day, from 0.9% to 2% of total halogens per day, from 1% to 2% of total halogens per day or from 1.5% to 2% of total halogens per day upon flowing of a flue gas stream over at least one surface of the article over a time period of at least 90 days.

In some embodiments, a release rate of total halogens from the article ranges from 0.1% to 1.5% of total halogens per day upon flowing of a flue gas stream over at least one surface of the article over a time period of at least 90 days. In some embodiments, a release rate of total halogens from the article ranges from 0.1% to 1% of total halogens per day, from 0.1% to 0.9% of total halogens per day, from 0.1% to 0.8% of total halogens per day, from 0.1% to 0.7% of total halogens per day, from 0.1% to 0.6% of total halogens per day, from 0.1% to 0.5% of total halogens per day, from 0.1% to 0.4% of total halogens per day, from 0.1% to 0.3% of total halogens per day or from 0.1% to 0.2% of total halogens per day, upon flowing of a flue gas stream over at least one surface of the article over a time period of at least 90 days.

In some embodiments, a release rate of total halogens from the article ranges from 0.2% to 0.9% of total halogens per day upon flowing of a flue gas stream over at least one surface of the article over a time period of at least 90 days. In some embodiments, a release rate of total halogens from the article ranges from 0.3% to 0.8% of total halogens per day, from 0.4% to 0.7% of total halogens per day or from 0.5% to 0.6% of total halogens per day upon flowing of a flue gas stream over at least one surface of the article over a time period of at least 90 days.

In some embodiments, the flue gas stream has a temperature of at least 20° C. and a relative humidity of at least 95%. In some embodiments, the flue gas stream comprises at least one SOₓ compound in a concentration of at least 1 ppm, and mercury vapor in a concentration of at least 1 μg/m³ of the flue gas stream.

In some embodiments, the flue gas stream has a temperature of at least 50° C. and a relative humidity of at least 95%. In some embodiments, the flue gas stream comprises at least one SOₓ compound in a concentration of at least 20 ppm, and mercury vapor in a concentration of at least 1 μg/m³ of the flue gas stream.

In some embodiments, the flue gas stream has a temperature greater than 20° C., greater than 30° C., greater than 40° C., greater than 50° C., greater than 60° C., greater than 70° C., greater than 75° C., greater than 80° C., greater than 85° C. or greater than 90° C.

In some embodiments, the flue gas stream has a temperature less than 20° C., less than 30° C., less than 40° C., less than 50° C., less than 60° C., less than 70° C., less than 75° C., less than 80° C., less than 85° C. or less than 90° C.

In some embodiments, the flue gas stream has a temperature from 20° C. to 80° C., from 30° C. to 80° C., from 40° C. to 80° C., from 50° C. to 80° C., from 60° C. to 80° C. or from 70° C. to 80° C.

In some embodiments, the flue gas stream has a temperature from 20° C. to 70° C., from 20° C. to 60° C., from 20° C. to 50° C., from 20° C. to 40° C. or from 20° C. to 30° C.

In some embodiments, the flue gas stream has a temperature from 30° C. to 70° C. In some embodiments, the flue gas stream has a temperature from 40° C. to 60° C.

In some embodiments, the flue gas stream has a temperature from 50° C. to 70° C., from 60° C. to 70° C., from 55° C. to 70° C., or from 55° C. to 60° C.

In some embodiments, the flue gas stream has a temperature of from 65° C. to 70° C., from 70° C. to 75° C., from 75° C. to 80° C., from 80° C. to 85° C., or from 85° C. to 90° C.

In some embodiments, the flue gas stream has a temperature of from 65° C. to 90° C., from 70° C. to 90° C., from 75° C. to 90° C., from 80° C. to 90° C., or from 85° C. to 90° C.

In some embodiments, the flue gas stream has a temperature of from 65° C. to 75° C., from 65° C. to 80° C., from 65° C. to 85° C., or from 65° C. to 90° C.

In some embodiments, the flue gas stream has a relative humidity of at least 95%. In some embodiments, the flue gas stream has a relative humidity of at least 96%, of at least 97%, of at least 98%, or of at least 99. In some embodiments, the flue gas stream has a relative humidity of 100%.

In some embodiments, the flue gas stream has a relative humidity of from 95% to 100%. In some embodiments, the flue gas stream has a relative humidity of from 96% to 100%, from 97% to 100%, from 98% to 100% or from 99% to 100%.

In some embodiments, the flue gas stream has a relative humidity of from 95% to 96%, from 95% to 97%, from 95% to 98%, from 95% to 99%, or from 95% to 100%.

In some embodiments, the flue gas stream does not comprise at least one SOₓ compound. In some embodiments, the flue gas stream comprises at least one SOₓ compound in a concentration of at least 1 ppm, of at least 5 ppm, of at least 10 ppm, of at least 20 ppm, of at least 25 ppm, of at least 30 ppm, of at least 35 ppm, of at least 40 ppm, of at least 45 ppm, of at least 50 ppm, of at least 100 ppm, of at least 500 ppm, or of at least 1000 ppm.

In some embodiments, the flue gas stream comprises at least one SOₓ compound in a concentration of from 1 ppm to 200 ppm, from 5 ppm to 200 ppm, from 10 ppm to 200 ppm, from 50 ppm to 200 ppm, or from 100 ppm to 200 ppm.

In some embodiments, the flue gas stream comprises at least one SOₓ compound in a concentration of from 20 ppm to 100 ppm, from 25 ppm to 100 ppm, from 30 ppm to 100 ppm, from 35 ppm to 100 ppm, from 40 ppm to 100 ppm, from 45 ppm to 100 ppm, from 50 ppm to 100 ppm, from 55 ppm to 100 ppm, from 60 ppm to 100 ppm, from 65 ppm to 100 ppm, from 70 ppm to 100 ppm, from 75 ppm to 100 ppm, from 80 ppm to 100 ppm, from 85 ppm to 100 ppm, from 90 ppm to 100 ppm, or from 95 ppm to 100 ppm.

In some embodiments, the flue gas stream comprises at least one SOₓ compound in a concentration of from 20 ppm to 25 ppm, from 20 ppm to 30 ppm, from 20 ppm to 35 ppm, from 20 ppm to 40 ppm, from 20 ppm to 45 ppm, from 20 ppm to 50 ppm, from 20 ppm to 55 ppm, from 20 ppm to 60 ppm, from 20 ppm to 65 ppm, from 20 ppm to 70 ppm, from 20 ppm to 75 ppm, from 20 ppm to 80 ppm, 20 ppm to 85 ppm, from 20 ppm to 90 ppm, from 20 ppm to 95 ppm, or from 20 ppm to 100 ppm.

In some embodiments, the flue gas stream comprises at least one SOₓ compound in a concentration of from 1 ppm to 90 ppm, from 1 ppm to 80 ppm, from 1 ppm to 70 ppm, from 1 ppm to 60 ppm, from 1 ppm to 50 ppm, from 1 ppm to 40 ppm, from 1 ppm to 30 ppm, from 1 ppm to 20 ppm, from 1 ppm to 10 ppm, or from 1 ppm to 5 ppm.

In some embodiments, the flue gas stream does not comprise mercury vapor. In some embodiments, the flue gas stream comprises mercury vapor in a concentration of at least 1 μg/m³, of at least 2 μg/m³, of at least 3 μg/m³, of at least 4 μg/m³, of at least 5 μg/m³, of at least 6 μg/m³, of at least 7 μg/m³, of at least 8 μg/m³, of at least 9 μg/m³, of at least 10 μg/m³, of at least 15 μg/m³, of at least 20 μg/m³, or of at least 50 μg/m³ of the flue gas stream.

In some embodiments the flue gas stream comprises mercury vapor in a concentration of at from 1 μg/m³ to 50 μg/m³ of the flue gas stream. In some embodiments the flue gas stream comprises mercury vapor in a concentration of from 5 μg/m³ to 50 μg/m³, from 10 μg/m³ to 50 μg/m³, from 20 μg/m³ to 50 μg/m³, or from 40 μg/m³ to 50 μg/m³ of the flue gas stream.

In some embodiments, the flue gas stream comprises mercury vapor in a concentration of at from 1 μg/m³ to 10 μg/m³ of the flue gas stream. In some embodiments, the flue gas stream comprises mercury vapor in a concentration of at from 2 μg/m³ to 10 μg/m³, from 3 μg/m³ to 10 μg/m³, from 4 μg/m³ to 10 μg/m³, from 5 μg/m³ to 10 μg/m³, from 6 μg/m³ to 10 μg/m³, from 7 μg/m³ to 10 μg/m³, from 8 μg/m³ to 10 μg/m³, or from 9 μg/m³ to 10 μg/m³ of the flue gas stream.

In some embodiments, the flue gas stream comprises mercury vapor in a concentration of at from 1 μg/m³ to 2 μg/m³, from 1 μg/m³ to 3 μg/m³, from 1 μg/m³ and 4 μg/m³, from 1 μg/m³ and 5 μg/m³, from 1 μg/m³ to 6 μg/m³, from 1 μg/m³ to 7 μg/m³, from 1 μg/m³ to 8 μg/m³, or from 1 μg/m³ to 9 μg/m³ of the flue gas stream.

In some embodiments, the flue gas stream is flowed over at least one surface of the article over a time period of at least 100 days. In some embodiments, the flue gas stream is flowed over at least one surface of the article over a time period of at least 200 days, at least 300 days, of at least 400 days, of at least 500 days, of at least 600 days, of at least 700 days, of at least 800 days, of at least 900 days, of at least 1,000 days, of at least 2,000 days, of at least 3,000 days, of at least 4,000 days or of at least 5,000 days.

In some embodiments, the flue gas stream is flowed over at least one surface of the article over a time period of 100 days to 10,000 days. In some embodiments, the flue gas stream is flowed over at least one surface of the article over a time period of 500 days to 10,000 days, over a time period of 1,000 days to 10,000 days or over a time period of 5,000 days to 10,000 days.

In some embodiments, the flue gas stream is flowed over at least one surface of the article over a time period of 100 days to 5,000 days, over a time period of 100 days to 1,000 days or over a time period of 100 days to 500 days.

In some embodiments, the flue gas stream is flowed over at least one surface of the article over a time period of 500 days to 10,000 days or over a time period of 1,000 days to 5,000 days.

In some embodiments, the at least one of the plurality of halogen reservoirs is in the form of a reservoir particle, wherein the reservoir particle comprises first permeation control material and at least one halogen source, wherein the first permeation control material is in the form of a permeation control particle, and wherein the at least one halogen source is present at least on a surface of the permeation control particle.

In some embodiments, the reservoir particle further comprises a second permeation control material, wherein the second permeation control material surrounds the at least one halogen source on the surface of the permeation control particle. In some embodiments, the first permeation control material and the second permeation control material comprise the same material. In some embodiments, the first permeation control material and the second permeation control material comprise different materials.

In some embodiments, the plurality of halogen reservoirs takes the form of a plurality of reservoir clusters, wherein each reservoir cluster comprises a mixture of the at least one halogen source and the permeation control material.

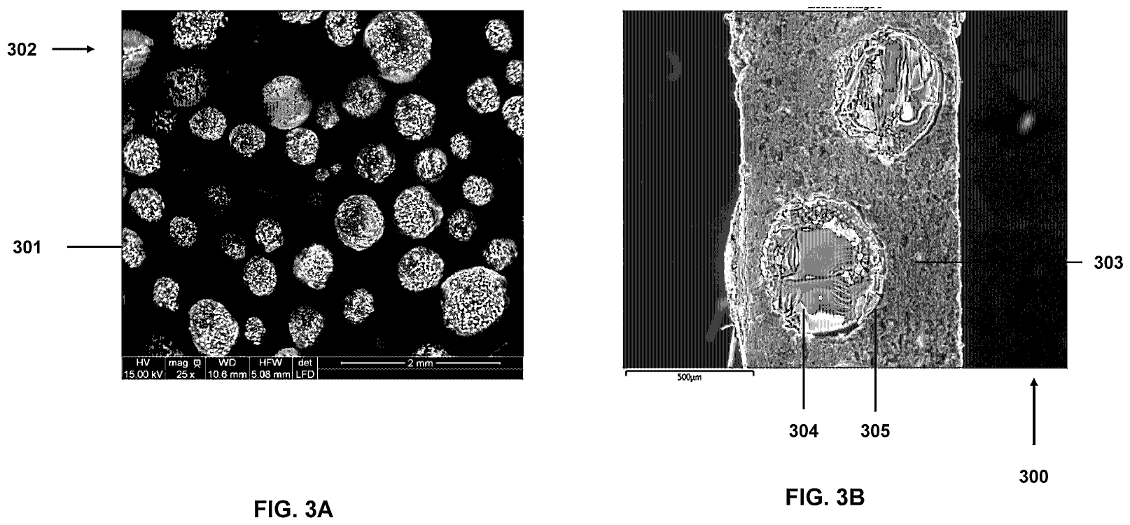

FIG. 3A depicts an electron image of a collection 302 of halogen reservoir particles 301 according to some non-limiting embodiments of the disclosure. FIG. 3B depicts an electron image of a cross section of a sorbent polymer composite (SPC) 303 comprising the halogen reservoir particles of FIG. 3A. The halogen reservoir particle 305 with permeation control material 304, embedded within the sorbent polymer composite (SPC) 303 according to some non-limiting embodiments of the disclosure.

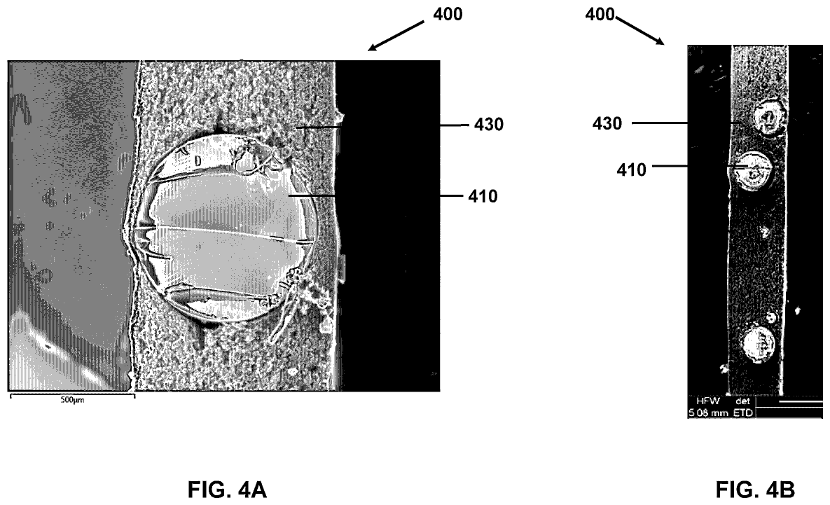

FIG. 4A depicts an enlarged electron image of an article 400 showing a cross section of a sorbent polymer composite (SPC) 430 comprising one halogen reservoir 410 in the form of a halogen reservoir particle embedded within the SPC 430 according to some non-limiting embodiments of the disclosure.

FIG. 4B depicts an electron image of an embodiment of article 400 showing a cross section of the sorbent polymer composite (SPC) 430 comprising halogen reservoirs comprising reservoir particle 410 embedded within the SPC 430.

In some embodiments, at least one of the plurality of halogen reservoirs takes the form of an encapsulated bead, wherein the encapsulated bead comprises a core. In some embodiments, the at least one halogen source is present at least on a surface of the core, wherein the permeation control material encapsulates the core forming an encapsulated bead.

The core may comprise any suitable material. For example, in some embodiments the core may comprise carbon, activated carbon derived from coal, lignite, wood, coconut shells, another carbonaceous material, a silica gel, a zeolite, or any combination thereof.

In some embodiments, the core comprises at least one carbon particle. In some embodiments, the at least one carbon particle could comprise any type of carbon particle listed herein. In some embodiments, the core comprises at least one carbon particle or a plurality of carbon particles.

In some embodiments, the at least one carbon particle or plurality of carbon particles comprises activated carbon. In some embodiments, the activated carbon is incorporated in the encapsulated bead in an amount ranging from 25 wt % to 50 wt % of the encapsulated bead.

In some embodiments, the activated carbon incorporated in the encapsulated bead is present in an amount of 25 wt % of the encapsulated bead, of 30 wt % of the encapsulated bead, of 35 wt % of the encapsulated bead, of 40 wt %, of 45 wt % or of 50 wt % of the encapsulated bead.

In some embodiments, the activated carbon incorporated in the encapsulated bead is present in an amount of 25 wt % to 30 wt %, of 25 wt % to 35 wt %, of 25 wt % to 40 wt % or of 25 wt % to 45 wt % of the encapsulated bead.

In some embodiments, the activated carbon incorporated in the encapsulated bead is present in an amount of 30 wt % to 50 wt %, of 35 wt % to 50 wt %, of 40 wt % to 50 wt %, of 45 wt % to 50 wt % of the encapsulated bead.

In some embodiments, the encapsulated bead comprises at least one permeation control material. In some embodiments, the permeation control material of the encapsulated bead comprises at least one polyvinylidene (PVDF) homopolymer or copolymer, at least one polyolefin, polycarbonate (PC), polystyrene (PS), ethyl cellulose (EC), or any combination thereof.

In some embodiments, the permeation control material of the encapsulated bead comprises a polyethylene wax. In some embodiments, the permeation control material of the encapsulated bead comprises a polypropylene wax.

In some embodiments, the encapsulated bead comprises at least one halogen source, wherein the at least one halogen source is present at least on a surface of at least one carbon particle.

In some embodiments, the encapsulated bead comprises a size range from 20 microns to 500 microns. In some embodiments, the release rate of the halogen increases with decreasing size of the encapsulated bead. In some embodiments, the encapsulated bead comprises a size range from 25 microns to 50 microns.

In some embodiments, the encapsulated bead comprises a size of 20 microns; a size of 25 microns; a size of 30 microns; a size of 35 microns; a size of 40 microns; a size of 45 microns; a size of 50 microns; a size of 100 microns; a size of 150 microns; a size of 200 microns; a size of 250 microns; a size of 300 microns; a size of 350 microns; a size of 400 microns; a size of 450 microns or a size of 500 microns

In some embodiments, the encapsulated bead comprises a size range from 20 microns to 25 microns; a size range from 20 microns to 30 microns; a size range from 20 microns to 35 microns; a size range from 20 microns to 40 microns; a size range from 20 microns to 45 microns; a size range from 20 microns to 50 microns; a size range from 20 microns to 100 microns; a size range from 20 microns to 150 microns; a size range from 20 microns to 200 microns; a size range from 20 microns to 250 microns; a size range from 20 microns to 300 microns; a size range from 20 microns to 350 microns; a size range from 20 microns to 400 microns; a size range from 20 microns to 450 microns or a size range from 20 microns to 500 microns.

In some embodiments, the encapsulated bead comprises a size range from 25 microns to 500 microns. In some embodiments, the encapsulated bead comprises a size range from 30 microns to 500 microns; from 35 microns to 500 microns; from 40 microns to 500 microns; from 45 microns to 500 microns; from 50 microns to 500 microns; from 100 microns to 500 microns; from 150 microns to 500 microns; from 200 microns to 500 microns; from 250 microns to 500 microns; from 300 microns to 500 microns; from 350 microns to 500 microns; from 400 microns to 500 microns or from 450 microns to 500 microns.

In some embodiments, the encapsulated bead may be prepared by any method known to those skilled in the art. In some embodiments, the encapsulated bead may be prepared by spray-drying, spray congealing, coextrusion, coating or coacervation.

In some embodiments, the encapsulated bead may be prepared by spray-drying. In some embodiments, the process of spray drying comprises suspension of the carbon particle in a solution of halogen source and the permeation control material, aerosolizing the suspension through a spray nozzle, evaporation of the solvent, thereby generating the encapsulated bead, and collecting the collection of encapsulated beads. In some embodiments, the at least one halogen source may be dissolved in solution, or pre-adsorbed on activated carbon.

In some embodiments, the solvent used for spray drying may be any low boiling solvent.

In some embodiments, the solvent used for spray drying may have a boiling point of less than 100° C. In some embodiments, the solvent used for spray drying may have a boiling point of less than 75° C. In some embodiments, the solvent used for spray drying may have a boiling point of less than 50° C.

In some embodiments, the solvent used for spray drying may have a boiling point of 50° C. to 100° C. In some embodiments, the solvent used for spray drying may have a boiling point of 75° C. to 100° C. In some embodiments, the solvent used for spray drying may have a boiling point of 50° C. to 75° C.

In some embodiments, the solvent used for spray drying may be any solvent that has the necessary solubility for the desired permeation control material.

In some embodiments, the solvent used for spray drying may be any solvent that has a solubility for the desired permeation control material of at least 5 wt %. In some embodiments, the solvent used for spray drying may be any solvent that has a solubility for the desired permeation control material of at least 25 wt %; of at least 50 wt % or of at least 75 wt %.

In some embodiments, the solvent used for spray drying may be any solvent that is unreactive to the at least one halogen source.

In some embodiments, the solvent may be methylene chloride (DCM), tetrahydrofuran (THF), ethyl acetate (EtOAc), acetone, toluene, or any combination thereof.

In some embodiments, the encapsulated bead may be prepared using spray coagulation. In some embodiments, the at least one halogen source may be pre-adsorbed on to the carbon particle. In some embodiments, the carbon particle is activated carbon. In some embodiments, the at least one halogen source that is pre-adsorbed on to the carbon particle can be mixed in a molten wax, aerosolized through a nozzle, solidified upon cooling, followed by collection of the encapsulated beads.

In some embodiments, the encapsulated bead can be incorporated into a sorbent polymer composite (SPC) using any process employed for the making of a sorbent polymer composite (SPC).

In some embodiments, the encapsulated bead content in the sorbent polymer composite (SPC) comprises 5 wt %; 10 wt %; 20 wt %; or 25 wt %.

In some embodiments, the encapsulated bead content in the sorbent polymer composite (SPC) comprises a range from 10 wt % to 30 wt %. In some embodiments, the encapsulated bead content in the sorbent polymer composite (SPC) comprises a range from 15 wt % to 30 wt %; from 20 wt % to 30 wt % or from 25 wt % to 30 wt %.

In some embodiments, the encapsulated bead content in the sorbent polymer composite (SPC) comprises a range from 10 wt % to 25 wt %; from 10 wt % to 20 wt % or from 10 wt % to 15 wt %.

In some embodiments, the quantity of the encapsulated bead content in the sorbent polymer composite (SPC) may be determined depending on the desired total halogen source content in the sorbent polymer composite (SPC), and the total halogen source content in the encapsulated beads. In some embodiments, the encapsulated bead comprises at least one halogen source content from 1 wt % to 50 wt %.

In some embodiments, the encapsulated bead comprises at least one halogen source content of at least 1 wt %; of at least 5 wt %; of at least 10 wt %; of at least 15 wt %; of at least 20 wt %; of at least 25 wt %; of at least 30 wt %; of at least 35 wt %; of at least 40 wt %; of at least 45 wt % or of about 50 wt %.

In some embodiments, the encapsulated bead comprises at least one halogen source content from 5 wt % to 50 wt %; from 10 wt % to 50 wt %; from 15 wt % to 50 wt %; from 20 wt % to 50 wt %; from 25 wt % to 50 wt %; from 30 wt % to 50 wt %; from 35 wt % to 50 wt %; from 40 wt % to 50 wt % or from 45 wt % to 50 wt %.

In some embodiments, the encapsulated bead comprises at least one halogen source content from 1 wt % to 5 wt %; from 1 wt % to 10 wt %; from 1 wt % to 15 wt %; from 1 wt % to 20 wt %; from 1 wt % to 25 wt %; from 1 wt % to 30 wt %; from 1 wt % to 35 wt %; from 1 wt % to 40 wt % or from 1 wt % to 45 wt %.

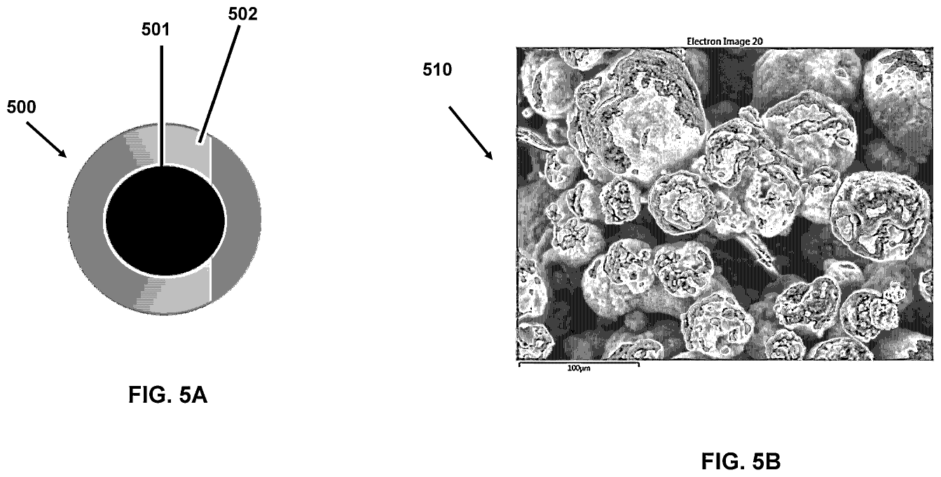

FIG. 5A depicts a halogen reservoir in the form of an encapsulated bead 500 according to some non-limiting embodiments of the present disclosure. As shown, the encapsulated bead 500 comprises a core 501. In some embodiments, the core 501 comprises at least one particle such as but not limited to at least one carbon particle. In some embodiments at least one halogen source (not shown) is present at least on a surface of the core 501. In some embodiments, the encapsulated bead 500 further comprises at least one permeation control material 502. In some embodiments, the permeation control material 502 encapsulates the core 501.

FIG. 5B depicts an electron image of a collection of encapsulated beads 510, according to some embodiments of the disclosure.

In some embodiments, the plurality of reservoir clusters takes the form of a plurality of discrete films embedded throughout the sorbent polymer composite (SPC).

FIG. 6A and FIG. 6B is a set of two photographs showing various implementations of halogen reservoirs incorporated into a sorbent polymer composite (SPC). FIG. 6A depicts a surface picture of an article 600 including halogen reservoir clusters 620 made of halogen reservoir agglomerates embedded within sorbent polymer composite (SPC) 610, according to some non-limiting embodiments of the disclosure. FIG. 6B depicts a surface picture of an article 600 including halogen reservoirs 620 embedded within sorbent polymer composite (SPC) 610, according to some non-limiting embodiments of the disclosure. As shown, halogen reservoir clusters 620 may take the form of localized regions, such as the streaks shown in FIG. 6B. In some embodiments, the localized regions may be formed by creating an agglomerated mixture of halogen reservoirs and embedding the agglomerated mixture throughout the sorbent polymer composite (SPC) 610.

In some embodiments, the article comprises a sufficient quantity of the plurality of halogen reservoirs so as to result in a release rate of total halogens from the article that does not exceed 0.5% of total halogens per day when a flue gas stream is flowed over at least one surface of the article over a time period of at least 90 days, wherein the flue gas stream has a temperature of at least 20° C. and a relative humidity of at least 95%, and wherein the flue gas stream comprises at least one SOₓ compound in a concentration of at least 1 ppm, and mercury vapor in a concentration of at least 1 μg/m³ of the flue gas stream.

In some embodiments, the article comprises a sufficient quantity of the plurality of halogen reservoirs so as to result in a release rate of total halogens from the article that does not exceed 2% of total halogens per day when a flue gas stream is flowed over at least one surface of the article over a time period of at least 90 days, wherein the flue gas stream has a temperature of at least 50° C. and a relative humidity of at least 95%, and wherein the flue gas stream comprises at least one SOₓ compound in a concentration of at least 20 ppm, and mercury vapor in a concentration of at least 1 μg/m³ of the flue gas stream.

In some embodiments, the sufficient quantity of the plurality of halogen reservoirs in the article is 5 wt % to 50 wt % of the plurality of halogen reservoirs based on a total weight of the article. In some embodiments, the sufficient quantity of the plurality of halogen reservoirs in the article is at least 5 wt %; at least 10 wt %; at least 15 wt %; at least 20 wt %; at least 25 wt %; at least 30 wt %; at least 35 wt %; at least 40 wt %; at least 45 wt % or at least 50 wt % of the plurality of halogen reservoirs based on a total weight of the article.

In some embodiments, the sufficient quantity of the plurality of halogen reservoirs in the article is 10 wt % to 50 wt % of the plurality of halogen reservoirs based on a total weight of the article. In some embodiments, the sufficient quantity of the plurality of halogen reservoirs in the article is 15 wt % to 50 wt %; 20 wt % to 50 wt %; 25 wt % to 50 wt %; 30 wt % to 50 wt %; 35 wt % to 50 wt %; 40 wt % to 50 wt % or 45 wt % to 50 wt % of the plurality of halogen reservoirs based on a total weight of the article.

In some embodiments, the sufficient quantity of the plurality of halogen reservoirs in the article is 5 wt % to 45 wt %; 5 wt % to 40 wt %; 5 wt % to 35 wt %; 5 wt % to 30 wt %; 5 wt % to 25 wt %; 5 wt % to 20 wt %; 5 wt % to 15 wt % or 5 wt % to 10 wt % of the plurality of halogen reservoirs based on a total weight of the article.

Some embodiments of the present disclosure relate to a method of obtaining an article comprising a sorbent polymer composite (SPC) and a plurality of halogen reservoirs.

In some embodiments, the plurality of halogen reservoirs is embedded within the SPC.

In some embodiments, each halogen reservoir of the plurality of halogen reservoirs comprises 5 wt % to 95 wt % of at least one permeation control material based on an average weight of each halogen reservoir, and 5 wt % to 50% of at least one halogen source based on an average weight of each halogen reservoir.

Some such embodiments relate to flowing a flue gas stream over at least one surface of the article over a time period of at least 90 days, wherein the gas stream has a temperature of at least 20° C. and a relative humidity of at least 95%, wherein the gas stream comprises at least one SOₓ compound in a concentration of at least 1 ppm, and mercury vapor in a concentration of at least 1 μg/m³ based on a total volume of the flue gas stream.

In some embodiments, a release rate of total halogens in the article does not exceed 0.5% of total halogens in the article per day during the flowing step. In some embodiments, a release rate of total halogens in the article does not exceed 0.6% of total halogens per day; does not exceed 0.7% of total halogens per day; does not exceed 0.8% of total halogens per day; does not exceed 0.9% of total halogens per day; does not exceed 1% of total halogens per day; does not exceed 1.5% of total halogens per day or does not exceed 2% of total halogens per day during the flowing step.

In some embodiments, at least one of the plurality of halogen reservoirs takes the form of an encapsulated bead, as described above. In some such embodiments, the encapsulated bead is formed by obtaining at least one particle so as to form a core, depositing the at least one halogen source at least onto a surface of the at least one particle, and encapsulating the core with at least one permeation control material, so as to form the encapsulated bead. In some embodiments, the at least one particle of the core comprises at least one carbon particle.

In some embodiments, the at least one halogen source is deposited as a solution at least onto a surface of the core. In some embodiments, the at least one halogen source is deposited as a solution at least onto a surface of the at least one carbon particle of the core.

In some embodiments, the at least one halogen source is deposited in the gas phase at least onto a surface of the core. In some embodiments, the at least one halogen source is deposited in the gas phase at least onto a surface of the at least one carbon particle of the core.

In some embodiments, at least one of the plurality of halogen reservoirs is in the form of a reservoir particle, as described above. In some embodiments, the reservoir particle is formed by obtaining the permeation control material in the form of a permeation control particle and depositing the at least one halogen source at least onto a surface of the permeation control particle.

In some embodiments, the method further comprises, after depositing the at least one halogen source at least onto a surface of the permeation control particle, depositing a second permeation control material on at least a portion of the reservoir particle, so as to form a second permeation control layer that surrounds the at least one halogen source. In some embodiments, the first permeation control material and the second permeation control material comprise the same material. In some embodiments, the first permeation control material and the second permeation control material comprise different materials.

In some embodiments, the plurality of halogen reservoirs is in the form of a plurality of reservoir clusters, wherein each of the plurality of reservoir clusters is formed by mixing a plurality of carbon particles with at least one halogen source and at least one permeation control material, so as to form a mixture, and embedding the mixture into the SPC.

In some embodiments, the method further comprising agglomerating the mixture so as to form an agglomerated mixture and embedding the agglomerated mixture into the SPC.

In some embodiments, the method further comprising forming the agglomerated mixture into a plurality of discrete films and embedding the discrete films throughout the SPC.

Some embodiments of the present disclosure relate to systems comprising any of the exemplary articles and/or embodiments of the articles disclosed herein. In some embodiments, the system includes a passageway configured for passage of gas stream therethrough. In some embodiments, the article is housed within the passageway. In some embodiments, at least a portion of the article is disposed to be in contact with the flue gas stream.

FIG. 11 depicts a non-limiting embodiment of a pollution control system 1100 having at least one of the article(s) described herein. Some non-limiting uses of the pollution control system 1100 can be for controlling air pollutant emissions to be in compliance with various air pollutant emissions standards. The pollution control system 1100 can be configured for capturing elemental and oxidized gas phase mercury from industrial flue gas. The pollution control system 1100 can include discrete stackable modules 1102 that can be installed downstream of a particulate collection system. In some embodiments, the modules 1102 can be configured with one or more embodiments of the article(s) 1104 (shown in an enlarged partial view in FIG. 11) described herein.

In some embodiments, the system can include several articles formed into a plurality of channels. In such embodiments, the gas stream can flow between the channels such that the gas stream is in direct contact with at least a part of the SPC, but not in direct contact with the reservoir. In some embodiments, the plurality of channels of the device can facilitate the flow of reactants, such as gaseous components, over one or more surfaces of the system and facilitate the drainage of at least one liquid product.

Non-limiting exemplary geometries of systems that can include the examples as described herein can be found in U.S. Pat. No. 9,381,459 to Stark et al., which is incorporated herein by reference in entirety for all purposes.

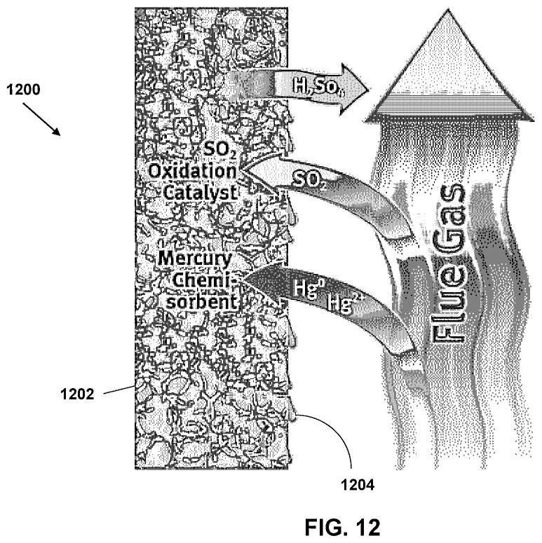

FIG. 12 depicts a non-limiting embodiment showing a schematic diagram 1200 of a flue gas flowing over a non-limiting embodiment of the article 1202 described herein. The article 1202 can capture both elemental and oxidized mercury from the flue gas stream as the flue gas flows past (e.g., over or through the material of the article 1202). Mercury can be securely bound within material of the article 1202 via chemisorption. SO₂ can also be adsorbed and/or absorbed and catalyzed (via SO₂ oxidation catalyst) to liquid sulfuric acid, which can form droplets 1204 and expelled from the article 1202. The droplets 1204 can flow downward via gravity on the surface of the article 1202.

Various examples of the articles and comparative examples have been tested to show the enhanced properties of the embodiments of the articles implemented into the embodied systems and processes also described herein. The results are described in detail below.

Test Methods

Simulated Flue Gas Stream Durability Test

The Simulated Flue Gas Stream Durability Test is a Laboratory Test. Exemplary tests for simulated exposure to flue gas stream were performed using an apparatus including:
(1) a supply of air regulated by a mass flow controller;
(2) a SO₂ source supplied by a gas cylinder containing an 1% sulfur dioxide/nitrogen mixture regulated through a mass flow controller;
(3) a triangular sample cell with 12 mm side length fitted with a bypass, and located in an oven maintained at 65° C.; while
(4) maintaining a high relative humidity of over 80% using a MH-070 permeation tube humidifier (PermaPure, NJ, USA). The samples were exposed in the apparatus as described above to a simulated flue gas stream containing 300 ppm/m³ SO₂ and a humidity of 90% at 1 (one) standard liters/min for a period of about three months. The total halogen (iodine) content of the samples was measured over time by X-ray Fluorescence (“XRF”) in wt %. The total halogen content of the samples was determined as total iodine content. Thus, the discussion of halogen content and release rate will be based on iodine content and the release rate of total iodine (total halogen) of the samples.

The relative iodine content was tracked over time according to the formula C_iodine/C_iodine_0 where C_iodine/C_ionine_0 is the total iodine content in the article at a time relative to the initial total iodine content in the article. The release rate of the total halogen was analyzed by tracking the relative iodine content using an exponential release rate (decay) function according to the formula C_iodine/C_iodine_0=exp(−k*time), where C_iodine is the total iodine content as measured in the respective sample over time, C_iodine_0 the initial total iodine content, and k the iodine release rate (content decay) constant with units of %/day. The total release rate is equal to k*C_iodine and the relative release rate is equal to k*C_iodine/C_iodine_0.

The total release rate is equal to the value of the release rate constant (for example, 0.5%/day) multiplied by the total halogens in the article. In other words, the release rate of total halogens from the article is, in this example, 0.5% of the total halogens in the article per day. The relative release rate and the release rate constant have the same units (%/day) but differ in value by the relative iodine content.

Sometimes, the iodine content was tracked over time according to the formula C_iodine=C_iodine_0*exp(−k*time), where C_iodine is the iodine content in the article and C_iodine_0 the initial iodine content, and k is the same iodine release rate (decay) constant as above with units of %/day. The exponential release rate (decay) model was used to estimate the depletion of the halogen source over a long time.

Flue Gas Stream Durability Test

The Flue Gas Stream Durability Test is a field test. Exemplary tests for exposure to an actual flue gas stream were performed by exposing SPC samples (representing the article of this disclosure) to a slipstream of a wet flue gas stream downstream from a desulfurization absorber unit on a coal fired powered plant. The samples were exposed to the flue gas stream in two configurations.

In the first configuration, up to six 3.5″×12″ (8.89 cm×30.48 cm) sheets of SPC supported on rods to enable unimpeded flow across the sheets were installed into a 3.5″×3.5″×40″ (8.89 cm×8.89 cm×101 cm) insulated sample fixture. The samples were exposed by pulling approximately 80 ACFM (actual cubic feet per minute), (137 m³/hr) of the flue gas stream through a series of pipes into the sample fixture by a fan.

In the second configuration, 1.25″ by 12″ (3.175 cm×30.48 cm) strips of SPC were installed on a frame fixture 2′×2′×1′ (61 cm×61 cm×30 cm) whereas the top and bottom of the strip was fixed in place along rails of the frame capable of holding up to 100 strips. The rails were separated by 2 inches (50 mm) to provide unimpeded flow across the frame. The frame was inserted into a 2.1′×2.1′×8′ (0.66 m×0.66 m×2.4 m) insulated Pilot Tower Unit. The samples were exposed by pulling approximately 2880 ACFM (4860 m³/hr) of the flue gas stream by means of a fan. Samples according to this disclosure were tested in either the first configuration or the second configuration or both. In both configurations, the flow rate and pressure differential were monitored across the sample fixture. By nature, the composition of the slipstream flue gas stream was highly variable, however the typical composition of the flue gas stream comprised a mercury concentration of 2 μg/m³, an SO₂ concentration of 20-40 ppm, an 02 concentration of 6%, a NO concentration of 200 ppm, and the relative humidity was >95%. The slipstream flue gas stream temperature was 50-55° C. Approximately once per month (every 30 days), a sample was taken and analyzed by X-ray Fluorescence (“XRF”) for total halogen (iodine) content in wt %. The total halogen content of the samples of the disclosure was determined as total iodine content. Thus, the discussion of halogen content and release rate will be based on iodine content and the release rate of total iodine (total halogen) of the samples.

The total iodine content of each sample was converted to the iodine content relative to the initial iodine content (“relative iodine content”) and was tracked over time as described in the Tables below.

The release rate of total halogens corresponds to the release rate of iodine as analyzed by the examples of the inventions.

The release rate of total iodine was analyzed by tracking the relative iodine content using an exponential release rate (decay) function according to the formula

C_iodine/C_iodine_0=exp(−k*time),

where C_iodine is the total iodine content in the respective sample, C_iodine_0 the initial total iodine content, and k the iodine release (content decay) constant with units of %/day. The total release rate is equal to k*C_iodine and the relative release rate is equal to k C_iodine/C_iodine_0. The exponential release rate (decay) model was used to estimate the depletion of the halogen source over a long time.

### Example 1

Iodine Loaded Carbon

Iodine Loaded Carbon 1A. Iodine on carbon was prepared by mixing 25% of iodine with 75% of activated carbon (Norit PAC20BF, Cabot Inc., TX, USA). The mixture was heated to 60° C. in a sealed glass vessel for 4-6 hours, which resulted in an iodine loading of approximately 25% by weight.

Iodine Loaded Carbon 1B. Iodine loaded carbon was prepared by preparing a supersaturated solution of potassium iodide (KI) dissolved in water, adding activated carbon (NUCHAR SA-20, Ingevity, SC, USA) in the ratio of 75% KI solution to 25% carbon and stirring at 90° C. for approximately 10 minutes. The carbon was then spread out on a sheet of PTFE and dried in an oven at 120° C. for 24 hours.

Halogen Reservoir Pieces

Halogen Reservoir pieces 1A. A halogen reservoir slurry was prepared using 12% of Iodine Loaded Carbon 1A, 18% PVDF (Kynar® Superflex 2501-20, Arkema Inc., PA, USA), and 70% tetrahydrofuran (THF) solvent (I₂-carbon:PVDF=1:1.5). The slurry was then applied to a release liner by means of a slot die coating head to form a halogen reservoir film. The film thickness after drying was 6 mil (0.1524 mm). The halogen reservoir film (e.g., thin flat structure) was then cut into smaller well-defined pieces using an office paper shredder Fellowes Micro-Cut 16Ms Microshred Shredder (item #4922002, Fellowes, Inc., IL, USA). The chopped pieces had a rectangular shape with average sizes of approximately 4 mm×13 mm (0.156×0.5 in).

Halogen Reservoir pieces 1B. A mixture of Iodine Loaded Carbon 1A and PVDF powder (Kynar Superflex 2501-20, Arkema Inc., PA, USA) at a ratio of 33% impregnated carbon to 66% PVDF was prepared using the general dry blending methodology taught in U.S. Pat. No. 7,791,861 and using a calendaring step at 110° C. to produce 0.75 mm (30 mil) thick semi-continuous films or thin flat structures. These halogen reservoir films were then cut into smaller well-defined pieces using an office paper shredder Fellowes Micro-Cut 16Ms Microshred Shredder (item #4922002, Fellowes, Inc., IL, USA). The chopped pieces had a rectangular shape with average sizes of approximately 4 mm×13 mm (0.156×0.5 in).

Halogen Reservoir pieces 1C. A mixture of Iodine Loaded Carbon 1B and PVDF powder (Kynar Superflex 2501-20, Arkema Inc., PA, USA) at a ratio of 40% impregnated carbon to 60% PVDF was prepared using the general dry blending methodology taught in U.S. Pat. No. 7,791,861 and using a calendaring step at 110° C. to produce 0.75 mm (30 mil) thick semi-continuous films. These halogen reservoir films were then cut into smaller well-defined pieces using an office paper shredder Fellowes Micro-Cut 16Ms Microshred Shredder (item #4922002, Fellowes, Inc., IL, USA). The chopped pieces had a rectangular shape with average sizes of approximately 4 mm×13 mm (0.156×0.5 in).

Halogen Reservoir Pieces 1D. A halogen reservoir material was created under laboratory conditions comprised of 40% KI (potassium iodide), 10% activated carbon (NUCHAR SA-20, Ingevity, SC, USA) and 50% of permeation control material PVDF (Kynar Flex 2751-00, Arkema Inc., PA, USA) and was prepared using the general dry blending methodology taught in U.S. Pat. No. 7,791,861 and using a calendaring step at 145° C. at which the material melts to produce 3 mm thick halogen reservoir parts. These halogen reservoir parts were then cut into smaller well-defined pieces using an office paper shredder Fellowes Micro-Cut 16Ms Microshred Shredder (item #4922002, Fellowes, Inc., IL, USA). The chopped pieces had a rectangular shape with average sizes of approximately 4 mm×13 mm (0.156×0.5 in).

Halogen Reservoir pieces 1E. A halogen reservoir material was created under laboratory conditions comprised of 31% of KI, 6% activated carbon (NUCHAR SA-20, Ingevity, SC, USA), 11% PTFE and 52% of permeation control material PVDF (Kynar Flex 2751-00, Arkema Inc., PA, USA) and was prepared using the general dry blending methodology taught in U.S. Pat. No. 7,791,861 and using a calendaring step at room temperature to produce 2 mm thick halogen reservoir parts. These halogen reservoir parts were then broken by hand into various sizes ranging from pieces approximately 2 cm×2 cm to residual powder.

Halogen Reservoir Pieces 1F. A halogen reservoir material was created under laboratory conditions comprised of 29% of TBAI, 14% activated carbon (Norit PAC20BF, Cabot Inc., TX, USA), 9% PTFE and 48% of permeation control material PVDF (Kynar Flex 2751-00, Arkema Inc., PA, USA) and was prepared using the general dry blending methodology taught in U.S. Pat. No. 7,791,861 and using a calendaring step at room temperature to produce 2 mm thick halogen reservoir parts. These halogen reservoir parts were then cut into smaller well-defined pieces using an office paper shredder Fellowes 18-Sheet Cross-Cut 99Ci Powershred Commercial Shredder (item #3229901, Fellowes, Inc., IL, USA). The chopped pieces had a rectangular shape with average sizes of approximately 4 mm×38 mm (0.156×1.5 in).

Halogen Reservoir Pieces 1G. A halogen reservoir material was created under laboratory conditions comprised of 27% TBAI, 14% activated carbon (Norit PAC20BF, Cabot Inc., TX, USA), 14% PTFE and 45% permeation control material PVDF (Kynar Flex 2751-00, Arkema Inc., PA, USA) and was prepared using the general dry blending methodology taught in U.S. Pat. No. 7,791,861 and using a calendaring step at room temperature to produce approximately 2 mm thick halogen reservoir parts. These halogen reservoir parts were then cut into smaller pieces using an office paper shredder Fellowes 18-Sheet Cross-Cut 99Ci Powershred Commercial Shredder (item #3229901, Fellowes, Inc., IL, USA). The chopped pieces had a rectangular shape with a nominal size of approximately 4 mm×38 mm (0.156×1.5 in).

Halogen Reservoir Pieces 1H. A halogen reservoir material was created under laboratory conditions comprised of 20% TBAI, 20% activated carbon (Norit PAC20BF, Cabot Inc., TX, USA), 20% PTFE and 40% permeation control material PVDF (Kynar Flex 2751-00, Arkema Inc., PA, USA) and was prepared using the general dry blending methodology taught in U.S. Pat. No. 7,791,861 and using a calendaring step at room temperature to produce approximately 2 mm thick halogen reservoir parts. These halogen reservoir parts were then cut into smaller pieces using an office paper shredder Fellowes 18-Sheet Cross-Cut 99Ci Powershred Commercial Shredder (item #3229901, Fellowes, Inc., IL, USA). The chopped pieces had a rectangular shape with a nominal size of approximately 4 mm×38 mm (0.156×1.5 in).

Halogen Reservoir Pieces 1I. A halogen reservoir material was created under laboratory conditions comprised of 20% TBAI, 10% activated carbon (Norit PAC20BF, Cabot Inc., TX, USA), 50% PTFE and 20% permeation control material PVDF (Kynar Flex 2751-00, Arkema Inc., PA, USA) and was prepared using the general dry blending methodology taught in U.S. Pat. No. 7,791,861 and using a calendaring step at room temperature to produce approximately 2 mm thick halogen reservoir parts. These halogen reservoir parts were then cut into smaller pieces using an office paper shredder Fellowes 18-Sheet Cross-Cut 99Ci Powershred Commercial Shredder (item #3229901, Fellowes, Inc., IL, USA). The chopped pieces had a rectangular shape with a nominal size of approximately 4 mm×38 mm (0.156×1.5 in).

Halogen Reservoir Pieces 1J. A halogen reservoir material was created under laboratory conditions comprised of 10% TBAI, 5% activated carbon (Norit PAC20BF, Cabot Inc., TX, USA), 5% PTFE, and 80% permeation control material PVDF (Kynar Flex 2751-00, Arkema Inc., PA, USA) and was prepared using the general dry blending methodology taught in U.S. Pat. No. 7,791,861 and using a calendaring step at room temperature to produce approximately 2 mm thick halogen reservoir parts. These halogen reservoir parts were then cut into smaller pieces using an office paper shredder Fellowes 18-Sheet Cross-Cut 99Ci Powershred Commercial Shredder (item #3229901, Fellowes, Inc., IL, USA). The chopped pieces had a rectangular shape with a nominal size of approximately 4 mm×38 mm (0.156×1.5 in).

Halogen Reservoir Agglomerates

Halogen Reservoir Agglomerate 1A. A halogen reservoir precursor agglomerate was created under laboratory conditions comprised of 8% TBAI, 53% activated carbon (Norit PAC20BF, Cabot Inc., TX, USA), 23% PTFE and 17% of permeation control material PVDF (Kynar Flex 2751-00, Arkema Inc., PA, USA) and was prepared using the general dry blending methodology taught in U.S. Pat. No. 7,791,861 to produce a loose agglomerate.

Halogen Reservoir Agglomerate 1B. A halogen reservoir precursor agglomerate was created under laboratory conditions comprised of 10% TBAI, 10% activated carbon (Norit PAC20BF, Cabot Inc., TX, USA), 15% PTFE and 65% permeation control material PVDF (Kynar Flex 2751-00, Arkema Inc., PA, USA) and was prepared using the general dry blending methodology taught in U.S. Pat. No. 7,791,861 to produce a loose agglomerate.

Sorbent Polymer Composite (SPC) Agglomerates

SPC Agglomerate 1A. A precursor agglomerate was created under laboratory conditions comprised of 67% activated carbon (Norit PAC20BF, Cabot Inc., TX, USA) and 33% PTFE and was prepared using the general dry blending methodology taught in U.S. Pat. No. 7,791,861 to produce a loose agglomerate.

SPC Agglomerate 1B. A precursor agglomerate was created under laboratory conditions comprised of 64% activated carbon (Norit PAC20BF, Cabot Inc., TX, USA), 31% PTFE, and 5% sulfur and was prepared using the general dry blending methodology taught in U.S. Pat. No. 7,791,861 to produce a loose agglomerate.

SPC Agglomerate 1C. A precursor agglomerate was created under laboratory conditions comprised of 70% activated carbon (Norit PAC20BF, Cabot Inc., TX, USA) and 30% PTFE and was prepared using the general dry blending methodology taught in U.S. Pat. No. 7,791,861 to produce a loose agglomerate.

SPC Agglomerate 1D. A precursor agglomerate was created under laboratory conditions comprised of 76% activated carbon (Norit PAC20BF, Cabot Inc., TX, USA) and 24% PTFE and was prepared using the general dry blending methodology taught in U.S. Pat. No. 7,791,861 to produce a loose agglomerate.

SPC Agglomerate 1E. A precursor agglomerate was created under laboratory conditions comprised of 63% activated carbon (Norit PAC20BF, Cabot Inc., TX, USA), 27% PTFE, 4% TBAI, 4% sulfur, and 2% PVDF powder (Kynar Flex 2751-00, Arkema Inc., PA, USA) and was prepared using the general dry blending methodology taught in U.S. Pat. No. 7,791,861 to produce a loose agglomerate.

SPC Agglomerate 1F. A precursor agglomerate was created under laboratory conditions comprised of 68% activated carbon (Norit PAC20BF, Cabot Inc., TX, USA), 29% PTFE and 3% PVDF (Kynar Flex 2751-00, Arkema Inc., PA, USA) and was prepared using the general dry blending methodology taught in U.S. Pat. No. 7,791,861 to produce a loose agglomerate.

SPC Agglomerate 1G. A precursor agglomerate was created under laboratory conditions comprised of 62% activated carbon (Norit PAC20BF, Cabot Inc., TX, USA), 27% PTFE, 4% sulfur, 4% TBAI, and 3% PVDF (Kynar Flex 2751-00, Arkema Inc., PA, USA) and was prepared using the general dry blending methodology taught in U.S. Pat. No. 7,791,861 to produce a loose agglomerate.

SPC Agglomerate 1H. A precursor agglomerate was created under laboratory conditions comprised of 64% activated carbon (Norit PAC20BF, Cabot Inc., TX, USA), 27% PTFE, 4% sulfur (Sigma Aldrich), and 4% TBAI and was prepared using the general dry blending methodology taught in U.S. Pat. No. 7,791,861 to produce a loose agglomerate.

Sample 1A—Article Comprising SPC with Halogen Reservoir Pieces 1A. SPC Agglomerate 1A was gently mixed by hand with Halogen Reservoir Pieces 1A at a ratio of 83% SPC agglomerate and 17% halogen reservoir pieces to form a well distributed mixture, which was prepared using the general dry blending methodology taught in U.S. Pat. No. 7,791,861 and using a calendaring step at 110° C. to produce a sorbent polymer composite (SPC) approximately 0.9 mm thick.

Sample 1B—Article Comprising SPC with Halogen Reservoir Pieces 1B. SPC Agglomerate 1B was loosely tumbled in a closed container with Halogen Reservoir Pieces 1B at a ratio of 80% SPC agglomerate and 20% halogen reservoir pieces to form a well distributed mixture, which was then prepared using the general dry blending methodology taught in U.S. Pat. No. 7,791,861 and using a calendaring step at 140° C. to produce a sorbent polymer composite (SPC) approximately 1 mm thick.

Sample 1C—Article Comprising SPC with Halogen Reservoir Pieces 1C. SPC Agglomerate 1B was loosely tumbled in a closed container with Halogen Reservoir Pieces 1C at a ratio of 80% SPC agglomerate and 20% halogen reservoir pieces to form a well distributed mixture, which was then prepared using the general dry blending methodology taught in U.S. Pat. No. 7,791,861 and using a calendaring step at 140° C. to produce a sorbent polymer composite (SPC) approximately 1 mm thick.

Sample 1D—Article Comprising SPC with Halogen Reservoir Pieces 1D. SPC Agglomerate 1C was loosely tumbled in a closed container with Halogen Reservoir Pieces 1D to form a well distributed mixture, which was then prepared using the general dry blending methodology taught in U.S. Pat. No. 7,791,861 and using a calendaring step at 145° C. to produce a sorbent polymer composite (SPC) approximately 0.5 mm thick.

Sample 1E—Article Comprising SPC with Halogen Reservoir Pieces 1E. SPC Agglomerate 1C was loosely tumbled in a closed container with Halogen Reservoir Pieces 1E at a ratio of 70% SPC agglomerate and 30% halogen reservoir pieces to form a well distributed mixture, which was then prepared using the general dry blending methodology taught in U.S. Pat. No. 7,791,861 and using a calendaring step at 145° C. to produce a sorbent polymer composite (SPC) approximately 1.2 mm thick.

Sample 1F—Article Comprising SPC with Halogen Reservoir Pieces 1F. SPC Agglomerate 1D was loosely tumbled in a closed container with Halogen Reservoir Pieces 1F at a ratio of 67% SPC agglomerate and 33% halogen reservoir pieces to form a well distributed mixture, which was then prepared using the general dry blending methodology taught in U.S. Pat. No. 7,791,861 and using a calendaring step at 145° C. to produce a sorbent polymer composite (SPC) approximately 1.1 mm thick.

Sample 1G—Article Comprising SPC with Halogen Agglomerate 1A. SPC Agglomerate 1E was loosely tumbled in a closed container with Halogen Reservoir Agglomerate 1A at a ratio of 50% SPC agglomerate and 50% halogen reservoir agglomerate to form a well distributed mixture, which was then prepared using the general dry blending methodology taught in U.S. Pat. No. 7,791,861 and using a calendaring step at 145° C. to produce a sorbent polymer composite (SPC) approximately 1.1 mm (44 mil) thick.

Sample 1H—Article Comprising SPC with Halogen Reservoir Pieces 1H. SPC Agglomerate 1E was gently mixed by hand with Halogen Reservoir Pieces 1H at a ratio of 67% SPC agglomerate and 33% halogen reservoir pieces to form a well distributed mixture, which was then prepared using the general dry blending methodology taught in U.S. Pat. No. 7,791,861 and using a calendaring step at 145° C. to produce a sorbent polymer composite (SPC) approximately 1 mm thick.

Sample 1I—Article Comprising SPC with Halogen Reservoir Pieces 1F. SPC Agglomerate 1D was loosely tumbled in a closed container with Halogen Reservoir Pieces 1F at a ratio of 67% SPC agglomerate and 33% halogen reservoir pieces to form a well distributed mixture, which was then prepared using the general dry blending methodology taught in U.S. Pat. No. 7,791,861 and using a calendaring step at 145° C. to produce a sorbent polymer composite (SPC) approximately 1.1 mm (44 mil) thick.

Sample 1J—Article Comprising SPC with Halogen Reservoir Pieces 1G. SPC Agglomerate 1F was loosely tumbled in a closed container with Halogen Reservoir Pieces 1G at a ratio of 67% SPC agglomerate and 33% halogen reservoir pieces to form a well distributed mixture, which was then prepared using the general dry blending methodology taught in U.S. Pat. No. 7,791,861 and using a calendaring step at 145° C. to produce a sorbent polymer composite (SPC) approximately 1 mm (40 mil) thick.

Sample 1K—Article Comprising SPC with Halogen Reservoir Pieces 1H. SPC Agglomerate 1C was loosely tumbled in a closed container with Halogen Reservoir Pieces 1H at a ratio of 67% SPC agglomerate and 33% halogen reservoir pieces to form a well distributed mixture, which was then prepared using the general dry blending methodology taught in U.S. Pat. No. 7,791,861 and using a calendaring step at 145° C. to produce a sorbent polymer composite (SPC) approximately 0.9 mm thick.

Sample 1L—Article Comprising SPC with Halogen Reservoir Pieces 1I. SPC Agglomerate 1C was loosely tumbled in a closed container with Halogen Reservoir Pieces 1I at a ratio of 67% SPC agglomerate and 33% halogen reservoir pieces to form a well distributed mixture, which was then prepared using the general dry blending methodology taught in U.S. Pat. No. 7,791,861 and using a calendaring step at 145° C. to produce a sorbent polymer composite (SPC) approximately 1 mm thick.

Sample 1M—Article Comprising SPC with Halogen Agglomerate 1B. SPC Agglomerate 1G was loosely tumbled approximately 10 revolutions in a closed container with Halogen Reservoir Agglomerate 1B at a ratio of 33% SPC agglomerate and 67% halogen reservoir agglomerate to form a well distributed mixture, which was then prepared using the general dry blending methodology taught in U.S. Pat. No. 7,791,861 and using a calendaring step at 145° C. to produce a sorbent polymer composite (SPC) approximately 1 mm (40 mil) thick.

Sample 1N—Article Comprising Reservoir Composite from Halogen Reservoir Pieces 1J. SPC Agglomerate 1H was loosely tumbled in a closed container with Halogen Reservoir Agglomerate 1C at a ratio of 67% SPC agglomerate and 33% halogen reservoir agglomerate to form a well distributed mixture, which was then prepared using the general dry blending methodology taught in U.S. Pat. No. 7,791,861 and using a calendaring step at 145° C. to produce a sorbent polymer composite (SPC) approximately 1 mm thick.

Flue Gas Stream Durability Test. Samples 1A, 1G and 1I-1L were mounted in the flue gas stream durability test as described above and total iodine content was measured over time. The total iodine content was converted to the relative iodine content as described in Table 1 and in FIG. 7. The release rate constant (iodine content decay constant k) for sample 1A was 0.17%/day, for Sample 1I was 0.17%/day, for Sample 1J was 0.34%/day, for Sample 1G was 0.38%/day, for Sample 1K was 0.23%/day, and for Sample 1L was 0.42%/day.

TABLE 1
Flue Gas Stream Durability Test

| | Relative | | Relative | | Relative |
|---|---|---|---|---|---|
| | iodine | | iodine | | iodine |
| Time | content of | Time | content of | Time | content of |
| (days) | Sample 1A | (days) | Sample 1I | (days) | Sample 1J |
| 0 | 1.00 | 0 | 1.00 | 0 | 1.00 |
| 41 | 0.70 | 32 | 1.00 | 34 | 0.86 |
| 134 | 0.87 | 57 | 0.91 | 101 | 0.74 |
| | | 97 | 0.83 | 118 | 0.65 |

| | Relative | | Relative | | Relative |
|---|---|---|---|---|---|
| Time | iodine of | Time | iodine of | Time | iodine of |
| (days) | Sample 1G | (days) | Sample 1K | (days) | Sample 1L |
| 0 | 1.00 | 0 | 1.00 | 0 | 1.00 |
| 26 | 0.92 | 29 | 1.11 | 29 | 0.82 |
| 55 | 0.85 | 58 | 0.99 | 58 | 0.82 |
| 84 | 0.71 | | | | |

When the flue gas stream durability data was extrapolated using the exponential release rate model (as shown in FIG. 7 by respective dashed lines), Samples 1J, 1G, and 1L show iodine release for close to 2 years (about 550 to 700 days) before approaching 90% depletion (illustrated by horizontal line L). Extrapolation of Samples 1A, 1I, and 1K show iodine release well in excess of 3 years (1095 days) before reaching 90% depletion.

### Example 2

Encapsulated Beads (FIG. 5)

Iodine-PVDF-Activated Carbon (1:2:1) Encapsulated Beads 2A: A spinning disc atomization process was used to prepare the sample. 40 grams (g) of PVDF Kynar Flex 2751-00, Arkema Inc., PA, USA) was dissolved into 1695 gram of tetrahydrofuran (THF). 20 g of activated carbon (Norit PAC20BF, Cabot, Inc. TX, USA) and 20 gram of iodine (I) were then mixed in to form a uniform suspension. The suspension was then poured onto a 7.6 cm diameter disc at approximately 100-120 g/min. Spinning the disc at approximately 7000 rpm, the slurry was atomized into a 0.1 cubic meter cone-bottom tank heated to approximately 29° C. Air conveyed the dried powder through a cyclone for collection. 53.4 g of encapsulated beads were recovered. The resulting beads had a nominal particle size of 20-30 microns. A portion of the resulting beads was analyzed by X-ray Fluorescence (“XRF”) and shown to contain approximately 20.7 wt % Iodine. This result showed that formulation of activated carbon with iodine accomplishes the retention of iodine in the finished encapsulated bead during the spray drying process.

Iodine-PVDF-Activated Carbon (1:1:2) Encapsulated Beads 2B. A spinning disc atomization process was used to prepare the sample. 143 grams (g) of PVDF Kynar Flex 2751-00, Arkema Inc., PA, USA) was dissolved into 2500 g of tetrahydrofuran (THF). 143 g of iodine (I) was dissolved into the solution, followed by 286 grams of activated carbon (Norit PAC20BF, Cabot, Inc. TX, USA) to form a uniform suspension. The suspension was then poured onto a 7.6 cm diameter disc at approximately 100-120 g/min. Spinning the disc at approximately 7000 rpm, the slurry was atomized into a 0.1 cubic meter cone-bottom tank heated to approximately 29° C. Air conveyed the dried powder through a cyclone for collection. 544 g of microencapsulated beads were recovered after sieving through a 212 μm sieve. The resulting beads had a nominal particle size of 20-30 microns. A portion of the resulting beads was analyzed by X-ray Fluorescence (“XRF”) and shown to contain approximately 26.4 wt % Iodine. According to the above recipe, the maximum iodine content in this mixture would be theoretically 25 wt %. Increasing the activated carbon to polymer ratio to 2:1 enabled virtually all of iodine added to the formulation to be incorporated into the finished encapsulated bead.

Iodine-Polycarbonate-Activated Carbon (1:2:1) Encapsulated Beads 2C. A spinning disc atomization process was used to prepare the sample. 20 grams (g) of polycarbonate (Catalog #954, MW 36,000, Scientific Polymer Products, Inc, NY, USA) was dissolved into 250 gram of methylene chloride (DCM). 10 g of iodine (I) was dissolved into the solution, followed by 10 gram of activated carbon (Norit PAC20BF, Cabot, Inc. TX, USA) to form a uniform suspension. The suspension was then poured onto a 7.6 cm diameter disc at approximately 100-120 g/min. Spinning the disc at approximately 7000 rpm, the slurry was atomized into 0.1 cubic meter cubed cone-bottom tank heated to approximately 40° C. Air conveyed the dried powder through a cyclone for collection. 33.2 g of encapsulated beads were recovered after sieving through a 212 μm sieve. The resulting beads had a nominal particle size of 20-30 microns. A portion of the resulting beads was analyzed by X-ray Fluorescence (“XRF”) and shown to contain approximately 21.3 wt % Iodine. According to the above recipe, the maximum iodine content in this mixture would be theoretically 25 wt %.

Iodine-Ethyl Cellulose-Activated Carbon (1:2:1) Encapsulated Beads 2D. A spinning disc atomization process was used to prepare the sample. 20 gram (g) of ethyl cellulose (Ethocel Standard 4, DuPont de Nemours, Inc., DE, USA) was dissolved into 330 g of methanol (MeOH). 10 g of iodine (I) was dissolved into the solution, followed by 10 g of activated carbon (Norit PAC20BF, Cabot, Inc. TX, USA) to form a uniform suspension. The suspension was then poured onto a 7.6 inch diameter disc at approximately 100-120 g/min. Spinning the disc at approximately 7000 rpm, the slurry was atomized into a 0.1 cubic meter cone-bottom tank heated to approximately 29° C. Air conveyed the dried powder through a cyclone for collection. 36 grams of encapsulated beads were recovered after sieving through a 212 μm sieve. The resulting beads had a nominal particle size of 20-30 microns. A portion of the resulting beads was analyzed by X-ray Fluorescence (“XRF”) and shown to contain approximately 23.3 wt % Iodine. According to the above recipe, the maximum iodine content in this mixture would be theoretically 25 wt %.

Sorbent Polymer Composites of Encapsulated Bead Samples 2A-2C. Sorbent polymer composites were created under laboratory conditions comprised of 67% activated carbon (Norit PAC20BF, Cabot Inc., TX, USA), 22% PTFE, 11% encapsulated beads, and were prepared using the general dry blending methodology taught in U.S. Pat. No. 7,791,861 to form composite samples. Sorbent polymer composite (SPC) Samples 2A-2C were formulated using the encapsulated beads described in Examples 2B-2D, respectively, as summarized in Table 2. A portion of the SPC sample was analyzed by X-ray Fluorescence (“XRF”) to ensure iodine was retained during processing. The results are shown in Table 2:

TABLE 2
Non-Limiting Embodiments of encapsulated Beads

| | Encapsulated | | initial Iodine | Initial Iodine |
|---|---|---|---|---|
| | Bead | | content of | content of |
| SPC Sample | Example | Polymer type | beads (wt %) | SPC (wt %) |
| Sample 2A | Example 2B | Polyvinylidene | 26.4 | 2.76 |
| | | fluoride | | |
| Sample 2B | Example 2C | Polycarbonate | 21.3 | 2.13 |
| Sample 2C | Example 2D | Ethyl Cellulose | 23.3 | 2.27 |

To provide sufficient rigidity for field testing, two (2) 3.5″×12″ strips of each material were laminated using a 2 mil PVDF film (SOLEF PVDF 9009, Solvay Specialty Polymers, LLC, DE, USA) in a belt laminator at ˜170° C. and roughly 60-80 psig roller pressure.

Flue Gas Stream Durability Test. Samples 2A-1, 2A-II 2B, and 2C were mounted in the flue gas stream durability test as described above and the total iodine content was measured over time. The total iodine content was converted to the iodine content relative to the initial iodine content as shown in Table 3.

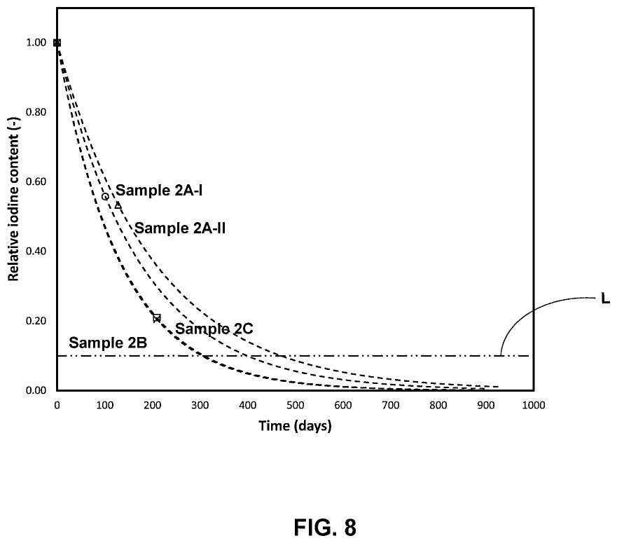

The halogen release rate constant k (iodine decay rate) was determined to be 0.58%/day for sample 2A-I and 0.49% for sample 2A-II, 0.75%/day for Sample 2B, and 0.76% for Sample 2C as shown in Table 3 and in FIG. 8. When the flue gas stream durability data was extrapolated using the exponential release rate model (as shown in FIG. 8 by respective dashed lines), sample 2A-I reached 90% iodine depletion (illustrated by horizontal line L) in about 450 days, sample 2A-II reached 90% iodine depletion in about 400 days while Sample 2B and Sample 2C reach 90% iodine depletion after about 300 days.

TABLE 3
Iodine Durability Test results

| | | Initial | Final | | |
|---|---|---|---|---|---|
| | | Iodine | Iodine | | |
| | Time of | Content | Content | Iodine | |
| | Exposure | of SPC | of SPC | retention | k |
| SPC Sample | (days) | (wt %) | (wt %) | (%) | (%/day) |
| Sample 2A-I | 101 | 2.76 | 1.540 | 56 | 0.58 |
| Sample 2A-II | 128 | 2.76 | 1.473 | 53 | 0.49 |
| Sample 2B | 209 | 2.13 | 0.448 | 21 | 0.75 |
| Sample 2C | 209 | 2.27 | 0.466 | 21 | 0.76 |

### Example 3

Iodine Loaded Reservoir Particles

Iodine Loaded Reservoir Particles 3A. Iodine loaded Polystyrene particles were prepared by mixing 20% of iodine with 80% of Polystyrene (PS) beads (Poly-Fil Micro Beads, part #PFMB, Fairfield Processing Corp., CT, USA) by shaking the mixture vessel for several times for one hour to mix the iodine with the beads. The mixture was then heated to 80° C. in a sealed vessel for 20 hours. A portion of the sample was analyzed by X-ray Fluorescence (“XRF”) and shown to contain approximately 20.2% Iodine.

Iodine Loaded Reservoir Particles 3B. Cross-linked polystyrene-divinylbenzene (PS-DVB) beads (Amberlite XAD4, Sigma-Aldrich, MO, USA) were dispersed in a glass baking dish and placed in an oven at 120° C. until completely dried. The dried beads were then mixed in a ratio of 75% to 25% with iodine by shaking the mixture vessel for several times for one hour. The mixture was then heated to 80° C. in a sealed vessel for 16 hours. A portion of the sample was analyzed by X-ray Fluorescence (“XRF”) and shown to contain approximately 24.3% Iodine.

Iodine Loaded Reservoir Particles 3C. Cross-linked polystyrene-divinylbenzene (PS-DVB) beads (Amberlite XAD4, Sigma-Aldrich, MO, USA) were washed multiple times to remove impurities that may impact mercury removal performance. 500 mL of deionized water and 200 grams of PS-DVB beads were added to a 1000 mL beaker, stirred, and then vacuum filtered. This washing procedure was repeated three times. The washed beads were then dispersed in a glass baking dish and placed in an oven at 120° C. until completely dried. The dried beads were mixed in a ratio of 75% to 25% with iodine by shaking the mixture vessel for several times for one hour. The mixture was then heated to 80° C. in a sealed vessel for 16 hours. A portion of the sample was analyzed by X-ray Fluorescence (“XRF”) and shown to contain approximately 24.5 wt % Iodine.

Permeation Control Materials

Solution 3A. A solution was prepared of 1.5 wt % PVDF (Kynar Superflex 2501-20, Arkema Inc., PA, USA) in tetrahydrofuran (THF) solvent.

Solution 3B. A solution was prepared of 4.0 wt % PVDF (Kynar Superflex 2501-20, Arkema Inc., PA, USA) in acetone (ACE) solvent.

Iodine Loaded Particles with Permeation Control Material

Coated Reservoir Particle 3A. A polymer layer may be added to the particles by any method known to those skilled in the art. One such process is fluid bed coating. Iodine Loaded Reservoir Particles 3B were coated with Solution 3A using a Fluid Air Feasibility Processor, a lab-scale fluid bed coater using a 1 L chamber with bottom spray. The unit was first charged with 100 g of iodine loaded beads 3B. The inlet temperature of the fluid bed coater was set to 35° C., resulting in an outlet temperature of 25.3 to 29.1° C. and product temperature of 24.8 to 28.1° C. The inlet air flow was set to 25-30 standard cubic feet per hour (SCFH), atomizing air to 12 psig, and filter pressure to 98 psig. The permeation control material solution 3A was pumped into the atomizing nozzle at 2.5 g/min in successive coating runs until a loading of approximately 20% PVDF was achieved.

Coated Reservoir Particles 3B. Iodine Loaded Reservoir Particles 3C were coated with Solution 3B using a Fluid Air Feasibility Processor, a lab-scale fluid bed coater using a 1 L chamber with bottom spray. The unit was first charged with 75 g of iodine loaded particles 3B. The inlet temperature of the fluid bed coater was set to 45° C., resulting in an outlet temperature of 36.6 to 38.3° C. and product temperature of 39.1 to 40.2° C. The inlet air flow was set to 26-28 SCFH, atomizing air to 12 psig, and filter pressure to 95 psig. The permeation control material solution 3A was pumped into the atomizing nozzle at 2.1 g/min for in successive coating runs until a loading of approximately 50% PVDF was achieved.

Brunauer-Emmett-Teller (BET) Surface Area

To assure coverage of the permeation control material coating, the specific surface area of the particles was measured by nitrogen adsorption (BET). The BET surface area of the iodinated PS-DVB particles decreases with increasing coverage of the permeation control material coating. A BET surface area of 8.8 m²/g was measured for Coated Reservoir Particles 3B in comparison to a BET surface area of 631.4 m²/g for the uncoated particles. The Reduction of the surface area demonstrated that the coated Reservoir Particles 3B were well covered with the permeation control material.

Iodine Stability Test

The stability of the iodine loaded and coated particles was tested by exposing the samples to heat inside an oven at 60° C. for three months. The iodine loaded and coated particle samples were placed in a vial and then closed with a cap. The vial also included activated carbon to capture the lost iodine. The iodine content of the iodine loaded and coated particles before and after the test was determined by XRF. After three months (94-97 days) the percent of iodine loss for Iodine Loaded Reservoir Particles 3B was 13.0%, for Coated Reservoir Particles 3A was 6.9%, and for Coated Reservoir Particles 3B was 2.1%.

Samples with Reservoir Particle

Sample 3A—Article Comprising SPC with Iodine Loaded Reservoir Particles 3A. A sorbent polymer composite (SPC) was created under laboratory conditions comprised of 65 parts activated carbon (Norit PAC20BF, Cabot Inc., TX, USA), 20 parts PTFE and 5 parts of Iodine Loaded Reservoir Particles 3A and was prepared using the general dry blending methodology taught in U.S. Pat. No. 7,791,861 to form composite samples. A portion of the sample was analyzed by X-ray Fluorescence (“XRF”) and shown to contain approximately 1.11% Iodine.

Sample 3B—Article Comprising SPC with Iodine Loaded Reservoir Particles 3B. A sorbent polymer composite (SPC) was created under laboratory conditions comprised of 65 parts activated carbon (Norit PAC20BF, Cabot Inc., TX, USA), 20 parts PTFE and 15 parts of Iodine Loaded Reservoir Particles 3B and was prepared using the general dry blending methodology taught in U.S. Pat. No. 7,791,861 to form composite samples. A portion of the sample was analyzed by X-ray Fluorescence (“XRF”) and shown to contain approximately 3.75 wt % Iodine.

Sample 3C—Article Comprising SPC with Coated Reservoir Particles 3A. A sorbent polymer composite (SPC) was created under laboratory conditions comprised of 65 parts activated carbon (Norit PAC20BF, Cabot Inc., TX, USA), 20 parts PTFE and 15 parts of Coated Reservoir Particles 3A and was prepared using the general dry blending methodology taught in U.S. Pat. No. 7,791,861 to form composite samples. A portion of the sample was analyzed by X-ray Fluorescence (“XRF”) and shown to contain approximately 2.429 wt % Iodine.

Sample 3D—Article Comprising SPC with Coated Reservoir Particles 3B. A sorbent polymer composite (SPC) was created under laboratory conditions comprised of 65 parts activated carbon (Norit PAC20BF, Cabot Inc., TX, USA), 20 parts PTFE and 15 parts Coated Reservoir Particles 3B and was prepared using the general dry blending methodology taught in U.S. Pat. No. 7,791,861 to form composite samples. A portion of the sample was analyzed by X-ray Fluorescence (“XRF”) and shown to contain approximately 1.18% iodine.

Scanning Electron Micrograph. A scanning electron micrograph (SEM) image of the cross section of Sample 3C is shown in FIG. 3B. FIG. 3B is showing in a cross section two coated iodine loaded reservoir particles 305 embedded in the SPC material 303. It can be observed that the particles 305 are intact and the permeation control material coating of PVDF is visible after formation into an SPC.

Sample 3E—Article Comprising Laminated SPC with Iodine Loaded Reservoir Particles 3B. Two layers of the SPC from Sample 3B were matted and laminated on a belt laminator using 36-40 psig pressure and 185° C. A portion of the sample was analyzed by X-ray Fluorescence (“XRF”) and shown to contain approximately 3.74 wt % Iodine.

Simulated Flue Gas Stream Durability Test. Three samples of Sample 3E were exposed to the simulated flue gas stream described before for a period of one month. The iodine content before and after the test is measured by X-ray Fluorescence (XRF). The three samples displayed relative iodine content over this test of 0.24 0.47 and 0.64, respectively.

Flue Gas Stream Durability Test. The data for Sample 3E are summarized in Table 5 which displays relative iodine content of the SPC with iodinated beads after the flue gas durability test under flue gas stream conditions.

TABLE 5
relative Iodine content of the Sorbent Polymer Composite (SPC).

| | | relative | Iodine release rate |
|---|---|---|---|
| Sample | Days of | Iodine | constant (Decay |
| description | exposure | content | constant) (%/day) |
| Sample 3E | 0 | 1.00 | 0.50 |
| | 27 | 0.662 | |
| | 155 | 0.274 | |
| | 410 | 0.159 | |

### Comparative Example 1

SPC Comparative Sample 4A. A sorbent polymer composite (SPC) was created under laboratory conditions comprised of 40% activated carbon (NUCHAR SA-20, Ingevity, SC, USA), 50% PTFE, 3% potassium iodide (KI) as halogen source, and 7% sulfur and was prepared using the general dry blending methodology taught in U.S. Pat. No. 7,791,861 to form composite samples that were then uniaxially expanded according to the teachings of U.S. Pat. No. 3,953,566.

SPC Comparative Sample 4B. A sorbent polymer composite (SPC) was created under laboratory conditions comprised of 50% activated carbon (NUCHAR SA-20, Ingevity, SC, USA), 39% PTFE, 6% tetrabutylammonium iodide (TBAI) as halogen source, and 5% sulfur and was prepared using the general dry blending methodology taught in U.S. Pat. No. 7,791,861 to form composite samples that were then uniaxially expanded according to the teachings of U.S. Pat. No. 3,953,566.

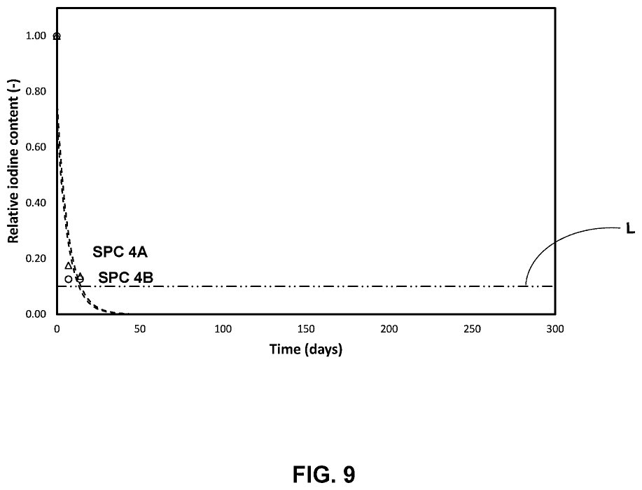

Simulated Flue Gas Stream Durability Test. SPC comparative samples 4A and 4B were mounted in the simulated flue gas durability test and the relative iodine content was tracked over time as described in Table 6. The halogen release rate constant (the iodine content decay constant k) was determined to be 17.7%/day for SPC Comparative Sample 4A, and 16.3%/day for SPC Comparative Sample 4B, as shown in FIG. 9. FIG. 9 shows the relative iodine content measured over a time period of 14 days. When the flue gas stream durability data was extrapolated using the exponential release rate (decay) model as shown also in FIG. 9 by respective dashed lines, SPC Comparative Samples 4A and 4B displayed iodine release for only about 15 days before approaching 90% depletion (illustrated by the horizontal line L).

TABLE 6
Simulated Flue Gas Stream Durability

| | Relative iodine | Relative iodine |
|---|---|---|
| Time (days) | content of Sample 4A | content of Sample 4B |
| 0 | 1.00 | 1.00 |
| 7 | 0.13 | 0.18 |
| 14 | 0.13 | 0.14 |

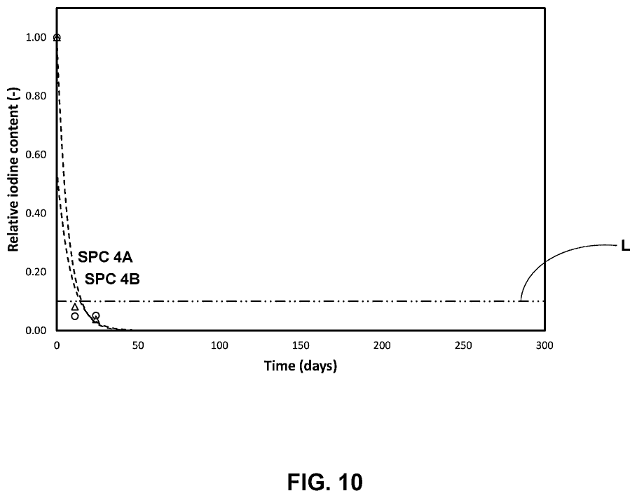

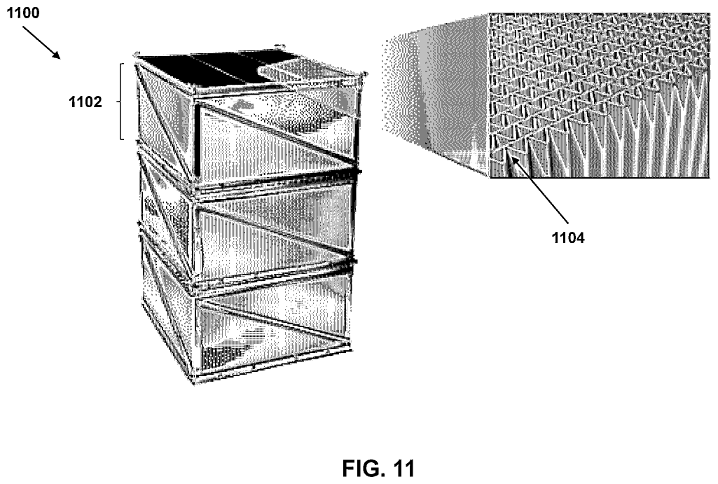

Flue Gas Stream Durability Test. SPC Comparative Samples 4A and 4B were mounted in the flue gas stream durability test. The relative iodine content was tracked over time as described in Table 7. The halogen release rate constant (iodine content decay constant k) was determined to be 15%/day for SPC Comparative Sample 4A, and 9.0%/day for SPC Comparative Sample 4B. As shown in Table 7 and FIG. 10, Comparative Samples 4A and 4B reach 90% iodine depletion in less than 10 days (as illustrated by horizontal line L). The relative iodine content of FIG. 10 was measured over a period of 24 and 51 days, respectively.

TABLE 7
Flue Gas Stream Durability Test

| | Relative iodine | Relative iodine |
|---|---|---|
| Time (days) | content of Sample 4A | content of Sample 4B |
| 0 | 1.00 | 1.00 |
| 11 | 0.05 | 0.08 |
| 24 | 0.05 | 0.04 |
| 51 | | 0.02 |

Aspects

Various Aspects are described below. It is to be understood that any one or more of the features recited in the following Aspect(s) can be combined with any one or more other Aspect(s).
Aspect 1. An article comprising:
   a sorbent polymer composite (SPC); and
   a plurality of halogen reservoirs,
      wherein the plurality of halogen reservoirs are embedded within the SPC,
      wherein each halogen reservoir of the plurality of halogen reservoirs comprises:
         5 wt % to 95 wt % of at least one permeation control material based on an average weight of each halogen reservoir, and
         5 wt % to 50% of at least one halogen source based on an average weight of each halogen reservoir.
Aspect 2. The article of Aspect 1, wherein the SPC comprises a polymer material.
Aspect 3. The article of Aspect 2, wherein the polymer material includes at least one of polyfluoroethylene propylene (PFEP); polyperfluoroacrylate (PPFA); polyvinylidene fluoride (PVDF); a terpolymer of tetrafluoroethylene, hexafluoropropylene and vinylidene fluoride (THV); polychlorotrifluoro ethylene (PCFE); poly(ethylene-co-tetrafluorethylene) (ETFE); ultrahigh molecular weight polyethylene (UHMWPE); polyethylene; polyparaxylylene (PPX); polyactic acid (PLLA); polyethylene (PE); expanded polyethylene (ePE); polytetrafluoroethylene (PTFE); expanded polytetrafluoroethylene (ePTFE); or any combination thereof.
Aspect 4. The article of Aspect 3, wherein the polymer material includes PVDF.
Aspect 5. The article of Aspect 4, wherein the PVDF is a PVDF homopolymer.
Aspect 6. The article of Aspect 4, wherein the PVDF is a PVDF copolymer.
Aspect 7. The article of Aspect 6, wherein the PVDF copolymer is a copolymer of PVDF and hexafluoropropylene (HFP).
Aspect 8. The article of Aspect 3, wherein the polymer material includes PTFE.
Aspect 9. The article of Aspect 3, wherein the polymer material includes ePTFE.
Aspect 10. The article according to any of Aspects 2-9, wherein the polymer material includes fibrils and nodes, wherein the polymer material becomes porous upon stretching, such that voids form between the fibrils and the nodes.
Aspect 11. The article according to any of Aspects 1-10, wherein the at least one halogen source includes at least a metal halide, an ammonium halide, an elemental halogen, or any combination thereof.
Aspect 12. The article according to any of Aspects 1-10, wherein the at least one halogen source includes at least sodium chloride, potassium chloride, sodium bromide, potassium bromide, sodium iodide, potassium iodide, or any combination thereof.
Aspect 13. The article according to any of Aspects 1-10, wherein the at least one halogen source includes at least an ammonium halide.
Aspect 14. The article according to any of Aspects 1-10, wherein the at least one halogen source includes at least tetramethylammonium iodide, tetrabutylammonium iodide, tetraethylammonium iodide, tetrapropylammonium iodide, tetramethylammonium bromide, tetraethylammonium bromide, tetrapropylammonium bromide, tetrabutylammonium bromide, tetrabutylammonium tri-iodide, tetrabutylammonium tri-bromide, tetrabutylammonium tri-chloride, tetramethylammonium chloride, tetraethylammonium chloride, tetrapropylammonium chloride, tetrabutylammonium chloride, or any combination thereof.
Aspect 15. The article according to any of Aspects 1-10, wherein the at least one halogen source includes at least an elemental halogen.
Aspect 16. The article of Aspect 15, wherein the elemental halogen is at least one of elemental iodine (I₂), elemental chlorine (Cl₂), or elemental bromine (Br₂).
Aspect 17. The article according to any of Aspects 1-10, wherein the at least one halogen source includes tetrabutylammonium iodide (TBAI).
Aspect 18. The article according to any of Aspects 1-10, wherein the at least one halogen source includes potassium iodide (KI).
Aspect 19. The article according to any of Aspects 1-10, wherein the at least one halogen source includes at least one phosphonium halide.
Aspect 20. The article of Aspect 19, wherein the at least one phosphonium halide comprises tetrabutylphosphonium iodide (TBPI), ethyltriphenylphosphonium triiodide (ETPPI₃), tetrabutylphosphonium bromide (TBPBr), ethyltriphenylphosphonium bromide (ETPPBr), ethyltriphenylphosphonium iodide (ETPPI), or any combination thereof. In some embodiments, the at least one phosphonium halide is selected from the group consisting of tetrabutylphosphonium iodide (TBPI), ethyltriphenylphosphonium triiodide (ETPPI₃), tetrabutyl phosphonium bromide (TBPBr), ethyltriphenylphosphonium bromide (ETPPBr), ethyltriphenylphosphonium iodide (ETPPI), or any combination thereof.
Aspect 21. The article of Aspect 20, wherein the at least one phosphonium halide is ETPPI.
Aspect 22. The article according to any of Aspects 1-21,
   wherein the article comprises a sufficient quantity of the plurality of halogen reservoirs, so as to result in a release rate of total halogens from the article that does not exceed 2% relative to total halogens in the article per day, under conditions where a flue gas stream is flowed over at least one surface of the article over a time period of at least 90 days;
      wherein the flue gas stream has a temperature of at least 20° C. and a relative humidity of at least 95%, and
      wherein the gas stream comprises at least one SOₓ compound in a concentration of at least 1 ppm, and mercury vapor in a concentration of at least 1 μg/m³ of the flue gas stream.
Aspect 23. The article according to any of Aspects 1-22,
   wherein at least one of the plurality of halogen reservoirs takes a form of an encapsulated bead,
      wherein the encapsulated bead comprises:
         a core;
         the at least one halogen source, wherein the at least one halogen source is present at least on a surface of the core; and
         the permeation control material, wherein the permeation control material encapsulates the core.
Aspect 24. The article of Aspect 23, wherein the core comprises activated carbon.
Aspect 25. The article according to any of Aspects 1-24,
   wherein at least one of the plurality of halogen reservoirs is in a form of a reservoir particle,
      wherein the reservoir particle comprises:
         the permeation control material, wherein the permeation control material is in a form of a permeation control particle; and
         the at least one halogen source, wherein the at least one halogen source is present at least on a surface of the permeation control particle.
Aspect 26. The article of Aspect 25, wherein the permeation control material includes polystyrene, a cross-linked polystyrene-divinylbenzene (PS-DVB), or a combination thereof.
Aspect 27. The article according to any of Aspect 25 or Aspect 26, wherein the reservoir particle further comprises a second permeation control material, wherein the second permeation control material surrounds the at least one halogen source on the surface of the permeation control particle.
Aspect 28. The article according to any of Aspects 1-22, wherein the plurality of halogen reservoirs takes a form of a plurality of reservoir clusters, wherein each of the reservoir clusters comprises:
   the at least one halogen source; and
   the permeation control material.
Aspect 29. The article of Aspect 28, wherein the plurality of reservoir clusters takes a form of a plurality of halogen reservoir pieces embedded throughout the SPC.
Aspect 30. The article of Aspect 28, wherein the plurality of reservoir clusters takes a form of a plurality of halogen reservoir agglomerates mixed with the SPC.
Aspect 31. The article of Aspect 22, wherein the sufficient quantity of the plurality of halogen reservoirs is 5 wt % to 75 wt % of the plurality of halogen reservoirs based on a total weight of the article.
Aspect 32. The article of Aspect 22, wherein the sufficient quantity of the plurality of halogen reservoirs is 5 wt % to 50 wt % of the plurality of halogen reservoirs based on a total weight of the article.
Aspect 33. The article according to any of Aspects 1-32,
   wherein the article comprises a sufficient quantity of the plurality of halogen reservoirs, so as to result in a release rate of total halogens from the article that does not exceed 0.5% relative to total halogens in the article per day, under conditions where a flue gas stream is flowed over at least one surface of the article over a time period of at least 90 days;
      wherein the flue gas stream has a temperature of at least 50° C. and a relative humidity of at least 95%, and
      wherein the gas stream comprises at least one SOₓ compound in a concentration of at least 20 ppm, and mercury vapor in a concentration of at least 1 μg/m³ of the flue gas stream.
Aspect 34. A method comprising:
   obtaining a sorbent polymer composite (SPC); and
   obtaining a plurality of halogen reservoirs,
      wherein each reservoir of the plurality of halogen reservoirs comprises:
         5 wt % to 95 wt % of at least one permeation control material based on an average weight of each halogen reservoir, and
         5 wt % to 50% of at least one halogen source by based on an average weight of each halogen reservoir; and
   forming article having the plurality of halogen reservoirs embedded within the SPC.
Aspect 35. The method of Aspect 34, wherein at least one of the plurality of halogen reservoirs takes a form of an encapsulated bead, wherein the method further comprises:
   forming the encapsulated bead by:
      obtaining at least one particle forming a core;
      depositing the at least one halogen source onto a surface of the at least one particle; and
      encapsulating the core with at least one permeation control material, so as to form the encapsulated bead.
Aspect 36. The method of Aspect 35, wherein the at least one halogen source is deposited as a solution onto the surface of the at least one particle.
Aspect 37. The method of Aspect 35, wherein the at least one halogen source is deposited in a gas phase onto the surface of the at least one particle.
Aspect 38. The method according to any of Aspects 35-37, wherein the at least one particle is a carbon particle.
Aspect 39. The method of Aspect 35, wherein at least one of the plurality of halogen reservoirs is in a form of a reservoir particle,
   wherein the reservoir particle is formed by:
      obtaining the at least one permeation control material in a form of a permeation control particle; and
      depositing the at least one halogen source onto a surface of the permeation control particle.
Aspect 40. The method of Aspect 39, the method further comprising:
   after depositing the at least one halogen source onto the surface of the permeation control particle, depositing a second permeation control material on at least a portion of the reservoir particle, so as to form a second permeation control layer that surrounds the at least one halogen source.
Aspect 41. The method of Aspect 34, wherein the plurality of halogen reservoirs is in a form of a plurality of reservoir clusters, wherein the method further comprises:
   forming each of the plurality of reservoir clusters by:
      mixing a plurality of particles with at least one halogen source and at least one permeation control material, so as to form a mixture;
      forming the mixture into films or parts;
      forming the films or parts into halogen reservoir pieces; and
      embedding the halogen reservoir pieces into the SPC.
Aspect 42. The method of Aspect 34, wherein the plurality of halogen reservoirs is in a form of a plurality of reservoir clusters, wherein the method further comprises:
   forming each of the plurality of reservoir clusters by:
      obtaining a SPC agglomerate;
      mixing a plurality of particles with at least one halogen source and at least one permeation control material to form a reservoir agglomerate; and
      mixing the SPC agglomerate with the reservoir agglomerate to form the article.
Aspect 43. The method according to any of Aspects 34-42, further comprising flowing a flue gas stream to contact the article, wherein the flue gas stream has a temperature of at least 50° C. and a relative humidity of at least 95%, wherein the flue gas stream comprises at least one SOₓ compound in a concentration of at least 20 ppm, and mercury vapor in a concentration of at least 1 μg/m³ based on a total volume of the flue gas stream, wherein a release rate of total halogens in the article does not exceed 0.5% relative to total halogens in the article per day.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. An article comprising:
a sorbent polymer composite (SPC); and
a plurality of halogen reservoirs,
wherein the plurality of halogen reservoirs are embedded within the SPC,
wherein each halogen reservoir of the plurality of halogen reservoirs comprises:
5 wt % to 95 wt % of at least one permeation control material based on an average weight of each halogen reservoir, and
5 wt % to 50% of at least one halogen source based on an average weight of each halogen reservoir.

2. The article of claim 1, wherein the SPC comprises a polymer material.

3. The article of claim 2, wherein the polymer material includes at least one of polyfluoroethylene propylene (PFEP); polyperfluoroacrylate (PPFA); polyvinylidene fluoride (PVDF); a terpolymer of tetrafluoroethylene, hexafluoropropylene and vinylidene fluoride (THV); polychlorotrifluoro ethylene (PCFE); poly(ethylene-co-tetrafluorethylene) (ETFE); ultrahigh molecular weight polyethylene (UHMWPE); polyethylene; polyparaxylylene (PPX); polyactic acid (PLLA); polyethylene (PE); expanded polyethylene (ePE); polytetrafluoroethylene (PTFE); expanded polytetrafluoroethylene (ePTFE); or any combination thereof.

4.-9. (canceled)

10. The article according to claim 2, wherein the polymer material includes fibrils and nodes, wherein the polymer material becomes porous upon stretching, such that voids form between the fibrils and the nodes.

11. The article according to claim 1, wherein the at least one halogen source includes at least a metal halide, an ammonium halide, an elemental halogen, or any combination thereof.

12.-14. (canceled)

15. The article according to claim 1, wherein the at least one halogen source includes at least an elemental halogen.

16. (canceled)

17. The article according to claim 1, wherein the at least one halogen source includes tetrabutylammonium iodide (TBAI), potassium iodide (KI), or phosphonium halide.

18.-19. (canceled)

20. The article of claim 19, wherein the at least one phosphonium halide comprises tetrabutylphosphonium iodide (TBPI), ethyltriphenylphosphonium triiodide (ETPPI₃), tetrabutylphosphonium bromide (TBPBr), ethyltriphenylphosphonium bromide (ETPPBr), ethyltriphenylphosphonium iodide (ETPPI), or any combination thereof. In some embodiments, the at least one phosphonium halide is selected from the group consisting of tetrabutylphosphonium iodide (TBPI), ethyltriphenylphosphonium triiodide (ETPPI₃), tetrabutyl phosphonium bromide (TBPBr), ethyltriphenylphosphonium bromide (ETPPBr), ethyltriphenylphosphonium iodide (ETPPI), or any combination thereof.

21. (canceled)

22. The article according to claim 1,
wherein the article comprises a sufficient quantity of the plurality of halogen reservoirs, so as to result in a release rate of total halogens from the article that does not exceed 2% of the total halogens in the article per day, under conditions where a flue gas stream is flowed over at least one surface of the article over a time period of at least 90 days,
wherein the flue gas stream has a temperature of at least 20° C. and a relative humidity of at least 95%, and
wherein the gas stream comprises at least one SOₓ compound in a concentration of at least 1 ppm, and mercury vapor in a concentration of at least 1 μg/m³ of the flue gas stream.

23. The article according to claim 1,
wherein at least one of the plurality of halogen reservoirs takes a form of an encapsulated bead,
wherein the encapsulated bead comprises:
a core;
the at least one halogen source, wherein the at least one halogen source is present at least on a surface of the core; and
the permeation control material, wherein the permeation control material encapsulates the core.

24. (canceled)

25. The article according to claim 1,
wherein at least one of the plurality of halogen reservoirs is in a form of a reservoir particle,
wherein the reservoir particle comprises:
the permeation control material, wherein the permeation control material is in a form of a permeation control particle; and
the at least one halogen source, wherein the at least one halogen source is present at least on a surface of the permeation control particle.

26.-27. (canceled)

28. The article according to claim 1, wherein the plurality of halogen reservoirs takes a form of a plurality of reservoir clusters, wherein each of the reservoir clusters comprises:
the at least one halogen source; and
the permeation control material.

29.-32. (canceled)

33. The article according to claim 1,
wherein the article comprises a sufficient quantity of the plurality of halogen reservoirs, so as to result in a release rate of total halogens from the article that does not exceed 0.5% of the total halogens in the article per day, under conditions where a flue gas stream is flowed over at least one surface of the article over a time period of at least 90 days;
wherein the flue gas stream has a temperature of at least 50° C. and a relative humidity of at least 95%, and
wherein the gas stream comprises at least one SOₓ compound in a concentration of at least 20 ppm, and mercury vapor in a concentration of at least 1 μg/m³ of the flue gas stream.

34. A method comprising:
obtaining a sorbent polymer composite (SPC); and
obtaining a plurality of halogen reservoirs,
wherein each reservoir of the plurality of halogen reservoirs comprises:
5 wt % to 95 wt % of at least one permeation control material based on an average weight of each halogen reservoir, and
5 wt % to 50% of at least one halogen source by based on an average weight of each halogen reservoir; and
forming article having the plurality of halogen reservoirs embedded within the SPC.

35. The method of claim 34, wherein at least one of the plurality of halogen reservoirs takes a form of an encapsulated bead, wherein the method further comprises:
forming the encapsulated bead by:
obtaining at least one particle forming a core;
depositing the at least one halogen source onto a surface of the at least one particle; and
encapsulating the core with at least one permeation control material, so as to form the encapsulated bead.

36.-37. (canceled)

38. The method according to claim 35, wherein the at least one particle is a carbon particle.

39. The method of claim 35, wherein at least one of the plurality of halogen reservoirs is in a form of a reservoir particle,
wherein the reservoir particle is formed by:
obtaining the at least one permeation control material in a form of a permeation control particle; and
depositing the at least one halogen source onto a surface of the permeation control particle.

40. The method of claim 39, the method further comprising:
after depositing the at least one halogen source onto the surface of the permeation control particle, depositing a second permeation control material on at least a portion of the reservoir particle, so as to form a second permeation control layer that surrounds the at least one halogen source.

41. The method of claim 34, wherein the plurality of halogen reservoirs is in a form of a plurality of reservoir clusters, wherein the method further comprises:
forming each of the plurality of reservoir clusters by:
mixing a plurality of particles with at least one halogen source and at least one permeation control material, so as to form a mixture;
forming the mixture into films or parts;
forming the films or parts into halogen reservoir pieces; and
embedding the halogen reservoir pieces into the SPC.

42. The method of claim 34, wherein the plurality of halogen reservoirs is in a form of a plurality of reservoir clusters, wherein the method further comprises:
forming each of the plurality of reservoir clusters by:
obtaining a SPC agglomerate;
mixing a plurality of particles with at least one halogen source and at least one permeation control material to form a reservoir agglomerate; and
mixing the SPC agglomerate with the reservoir agglomerate to form the article.

43. (canceled)
